(19) United States
(12) Patent Application Publication
(10) Pub. No.: US 2025/0280075 A1
(43) Pub. Date: Sep. 4, 2025

(54) INSPECTION SYSTEM, INSPECTION APPARATUS, AND METHOD OF CONTROLLING THE INSPECTION APPARATUS

(71) Applicant: CANON KABUSHIKI KAISHA, Tokyo (JP)

(72) Inventor: SATOSHI YOSHIDA, Kanagawa (JP)

(21) Appl. No.: 19/059,815

(22) Filed: Feb. 21, 2025

(30) Foreign Application Priority Data
Mar. 4, 2024 (JP) 2024-032524

(51) Int. Cl. H04N 1/00; G03G 15/00; G06T 7/00

(52) U.S. Cl. CPC H04N 1/00082; G03G 15/5062; G06T 7/001; H04N 1/00015; H04N 1/00029; H04N 1/00047; G06T 2207/10008

(57) ABSTRACT

An inspection system comprising an image forming apparatus that generates a printed material in accordance with a print job including print data and imposition information, and an inspection apparatus inspects the printed material. The inspection apparatus obtains a scan image of the printed material, makes inspection settings for a reference image, performs inspection by comparing the scan image and the reference image, and controls, in a case where the inspection settings include sequential number inspection and the imposition information indicates single-sided printing, to duplicate an inspection region set in the inspection settings for all pages. In a case where the sequential number inspection is set, the inspection apparatus performs data collating inspection for comparing the number set in the inspection settings with a collation value.

### BACKGROUND OF THE INVENTION

### Field of the Invention

The present invention relates to an inspection system, an inspection apparatus, and a method of controlling the inspection apparatus.

### Description of the Related Art

Conventionally, inspection (product inspection) for confirming whether a printed material is correctly printed has been performed manually. However, in recent years, an inspection apparatus that automatically performs inspection as post-processing of a printer has been used. This inspection apparatus registers, in advance, reference image data as a correct image. After that, an image is printed, by an image forming apparatus, on a sheet based on input image data, and is then read by a sensor provided in the inspection apparatus, thereby obtaining scan image data of the printed image. The scan image data is compared with the registered reference image data to detect a defect of the image printed on the sheet (printed material). Inspection for detecting a defect of a pattern portion of a printed product will be referred to as printed image inspection hereinafter.

Together with the printed image inspection, inspection of a variable region (variable data) such as a character string or a barcode printed by variable printing is performed. This inspection includes, for example, data legibility inspection for checking whether a character string or a barcode is legible, and data collating inspection for collating the reading result of the character string or the barcode with a correct answer and determining whether they match each other. The data legibility inspection and the data collating inspection will be referred to as data inspection hereinafter. An example of the data inspection is sequential number inspection. The sequential number inspection inspects data having sequential numerical values such as IDs, page numbers, or dates in a page of an inspection target image or between pages.

As a method of setting an inspection region for which sequential number inspection is performed, Japanese Patent Laid-Open No. 2020-53761 describes a method of setting an inspection region for each of the front and back sides of a sheet and reflecting the settings of the front side on an odd-numbered page and the settings of the back side on an even-numbered page.

However, in the method described in Japanese Patent Laid-Open No. 2020-53761, an inspection region is always set for each of an odd-numbered page (front side) and an even-numbered page (back side). Therefore, even for a printed material printed by a single-sided print job, it is necessary to set an inspection region for each of an odd-numbered page and an even-numbered page, and thus the setting operation and the like become a burden on an operator.

### SUMMARY OF THE INVENTION

Embodiments of the present disclosure eliminate the above-mentioned issues with conventional technology.

A feature of embodiments of the present disclosure is to provide a technique for setting a sequential number inspection region for all pages at once in the case of single-sided printing.

According to embodiments of the present disclosure, there is provided an inspection system comprising an image forming apparatus and an inspection apparatus, the image forming apparatus being configured to generate a printed material in accordance with a print job including print data and imposition information, and the inspection apparatus including one or more controllers including one or more processors and one or more memories, the one or more controllers configured to: obtain a scan image of the printed material by receiving and reading the printed material; make inspection settings for a reference image; perform inspection by comparing the scan image and the reference image; and control, in a case where the inspection settings include sequential number inspection for inspecting a sequential number as a consecutive number and the imposition information indicates single-sided printing, to duplicate an inspection region set in the inspection settings for all pages, wherein in the inspection, in a case where the sequential number inspection is set, the one or more controllers perform data collating inspection for comparing the number set in the inspection settings with a collation value.

According to embodiments of the present disclosure, there is provided an inspection apparatus comprising one or more controllers including one or more processors and one or more memories, the one or more controllers configured to: obtain a scan image of a printed material by receiving and reading the printed material generated in accordance with a print job including print data and imposition information; make inspection settings for a reference image; perform inspection by comparing the scan image and the reference image; and control, in a case where the inspection settings include sequential number inspection for inspecting a sequential number as a consecutive number and the imposition information indicates single-sided printing, to duplicate an inspection region set in the inspection settings for all pages, wherein in the inspection, in a case where the sequential number inspection is set, the one or more controllers perform data collating inspection for comparing the number set in the inspection settings with a collation value.

According to embodiments of the present disclosure, there is provided a method of controlling an inspection apparatus, comprising: obtaining a scan image of a printed material by receiving and reading the printed material generated in accordance with a print job including print data and imposition information; making inspection settings for a reference image; performing inspection by comparing the scan image and the reference image; and controlling, in a case where the inspection settings include sequential number inspection for inspecting a sequential number as a consecutive number and the imposition information indicates single-sided printing, to duplicate an inspection region set in the inspection settings for all pages, wherein in the performing inspection, in a case where the sequential number inspection is set, data collating inspection for comparing the number set in the inspection settings with a collation value is performed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view showing a configuration of an inspection system including an inspection apparatus according to a first embodiment of the present disclosure;

FIG. 2 is a block diagram for explaining hardware components of an image forming apparatus according to the first embodiment;

FIG. 3 is a block diagram for explaining a configuration of the inspection apparatus according to the first embodiment;

FIG. 4 is a block diagram for explaining a configuration of a print control apparatus according to the first embodiment;

FIG. 5 is a functional block diagram for explaining software components of the inspection apparatus, the image forming apparatus, and the print control apparatus of the inspection system according to the first embodiment;

FIG. 6 is a flowchart for explaining procedure of overall processing from a registration operation before the start of inspection to execution of inspection in the inspection apparatus according to the first embodiment;

FIG. 7 depicts a view showing an example of a job management screen displayed on a UI unit of the inspection apparatus according to the first embodiment;

FIGS. 8AA and 8AB depict views each showing an example of an inspection setting screen displayed on a UI unit of the inspection apparatus according to the first embodiment;

FIGS. 8BA and 8BB depict views each showing an example of an inspection setting screen in a case where a currently selected setting region is a sequential number inspection region in an inspection apparatus according to a second or fourth embodiment of the present disclosure;

FIG. 8C depicts a view showing an example of an inspection setting screen in a case where a currently selected setting region is a sequential number inspection region in the inspection apparatus according to a fifth embodiment;

FIGS. 9AA to 9AE depict views each illustrating a setting example of sequential number inspection and an example of a collation value according to the first embodiment;

FIGS. 9BA to 9BE depict views each illustrating a setting example of sequential number inspection and an example of a collation value according to the first embodiment;

FIG. 10 depicts a schematic sectional view for explaining the configuration of the image forming apparatus, the inspection apparatus, and a finisher (large capacity stacker) according to the first embodiment;

FIG. 11 is a flowchart for explaining inspection setting processing in step S603 of FIG. 6 according to the first embodiment;

FIG. 12 is a flowchart for explaining inspection processing in step S604 of FIG. 6 according to the first embodiment;

FIG. 13 is a flowchart for explaining processing of creating print data by the print control apparatus and inputting a job to the image forming apparatus and the inspection apparatus according to the first embodiment;

FIGS. 14A and 14B are flowcharts for explaining inspection setting processing in step S603 according to the second embodiment;

FIGS. 15AA to 15AC depict views showing examples of data for which inspection settings are to be made for all pages at once, sequential number settings, and a collation value table in a double-sided print job according to the second embodiment;

FIGS. 15BA to 15BC depict views showing examples of data, sequential number settings, and a collation value table when a blank page is deleted at the time of making inspection settings for all pages at once in a double-sided print job according to the third embodiment;

FIGS. 15CA to 15CC depict views showing examples of data in which a sequential number is not arranged intentionally, sequential number settings, and a collation value table when inspection settings are to be made for all pages at once in a double-sided print job according to the fourth embodiment;

FIGS. 15DA to 15DC depict views showing examples of data for which it is set whether to skip increasing/decreasing the collation value (sequential number) of an excluded page, sequential number settings, and a collation value table when inspection settings are to be made for all pages at once in a double-sided print job according to the fifth embodiment;

FIGS. 16A and 16B are flowcharts for explaining inspection setting processing in step S603 according to a third embodiment;

FIGS. 17A and 17B are flowcharts for explaining inspection setting processing in step S603 according to the fourth embodiment; and

FIGS. 18A and 18B are flowcharts for explaining inspection setting processing in step S603 according to the fifth embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted. Note that in the following description, an image forming apparatus is also called a multi-function peripheral (MFP) in some cases.

### First Embodiment

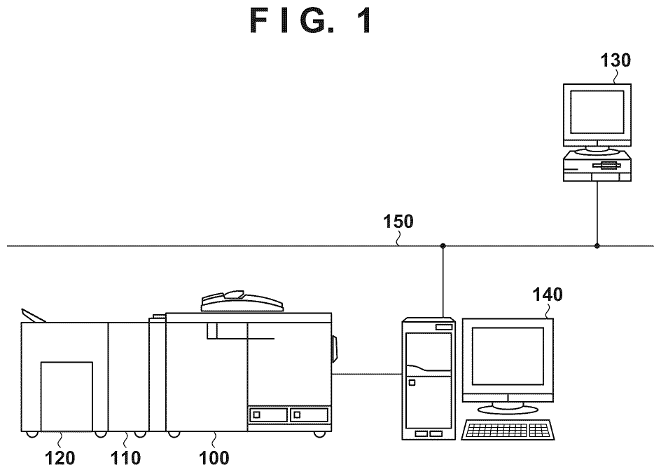

FIG. 1 depicts a view showing a configuration of an inspection system including an inspection apparatus 110 according to a first embodiment of the present disclosure. This inspection system includes an image forming apparatus 100, the inspection apparatus 110, a finisher 120, a print control apparatus 140, and a client PC 130.

The client PC 130 and the print control apparatus 140 are connected to each other via a network 150. The client PC 130 transmits image data or document data to the print control apparatus 140. The print control apparatus 140 generates, based on the received image data or document data, print data printable by the image forming apparatus 100, and transmits the print data to the image forming apparatus 100. The image forming apparatus 100 executes printing based on the print data transmitted from the print control apparatus 140, and discharges a generated printed material. The inspection apparatus 110 receives the printed material discharged from the image forming apparatus 100, and inspects whether the received printed material includes a defect. The defect degrades the quality of the printed material, and includes, for example, stains arising from attachment of a color material to an unintended portion at the time of printing, and a color omission arising from a failure of attachment of a sufficient amount of color material to an intended portion.

Furthermore, in variable printing including a variable region such as a character string or a barcode, the inspection apparatus 110 inspects the variable region. For example, the inspection apparatus 110 can perform data legibility inspection for checking whether a character string or a barcode is legible, and data collating inspection for collating the reading result of the character string or the barcode with a correct answer and determining whether they match each other. That is, the inspection apparatus 110 can perform printed image inspection for detecting a defect of a pattern portion of a printed material, and data inspection including data legibility inspection and data collating inspection. Note that in the first embodiment, sequential number inspection for data in which the numerical value of a data region is determined by a predetermined rule will be exemplified as data collating inspection. However, this is not intended to limit the present invention, and the target of data collating inspection need only be data determined by a predetermined rule. Other examples will be described in detail modifications to be described later.

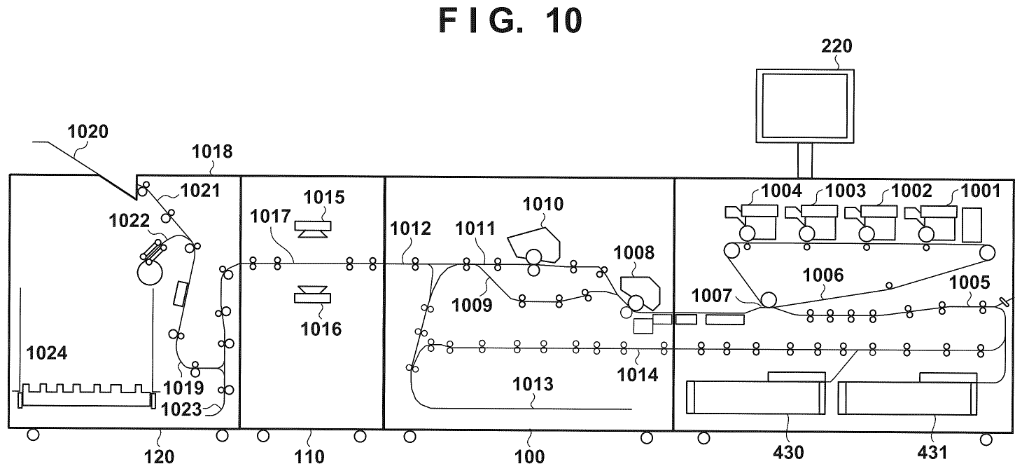

The finisher 120 receives the printed material inspected by the inspection apparatus 110, and switches the discharge destination of the printed material based on the inspection result of the inspection apparatus 110. More specifically, the finisher 120 stacks the printed material that has been determined not to include an image defect in the inspection by the inspection apparatus 110 on a main tray 1024 (FIG. 10), and discharges, to a top tray 1020 (FIG. 10), the printed material that has been determined to include an image defect. Note that a post-processing apparatus that can execute book binding, stapling, punching, or the like may further be connected to the finisher 120.

The image forming apparatus 100 is connected to the print control apparatus 140, the inspection apparatus 110, and the finisher 120 via communication cables. The inspection apparatus 110 is also connected to the finisher 120 via a communication cable, in addition to the image forming apparatus 100. In the first embodiment, as an example, an inline inspection system that consistently performs image formation (printing), product inspection (inspection), and sheet discharge will be described but this is not intended to limit the present invention. The network 150 may be a wired or wireless network.

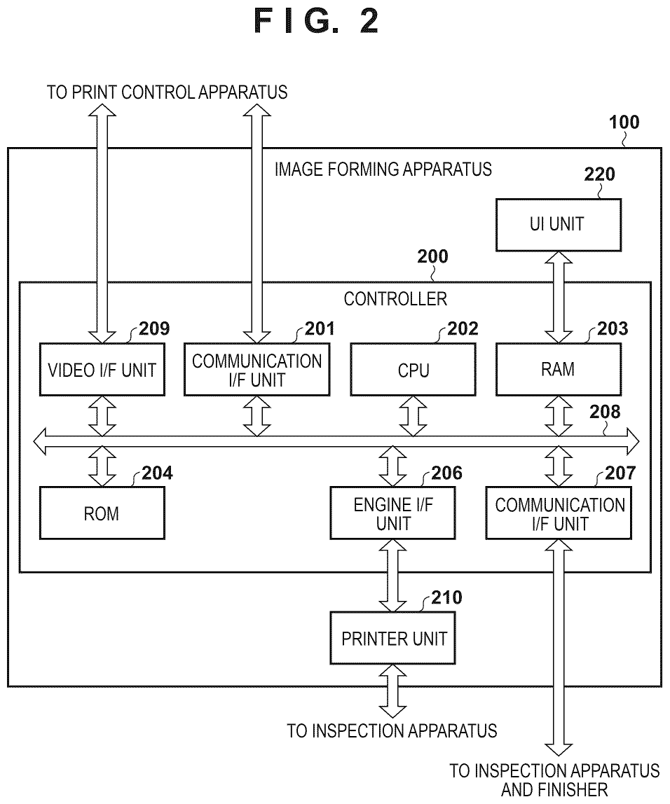

FIG. 2 is a block diagram for explaining hardware components of the image forming apparatus 100 according to the first embodiment.

A controller 200 analyzes bitmap data (image data) and job information received from the print control apparatus 140, and sends a print instruction to a printer unit 210. The printer unit 210 prints an image on a print sheet (paper or sheet) based on print data. A user interface (UI) unit 220 displays a screen, and accepts an instruction such as a selection instruction of sheet information for the image forming apparatus 100 from the user. The image forming apparatus 100 includes the above-described controller 200, printer unit 210, and UI unit 220.

The components of the controller 200 will be described next. A communication interface (I/F) unit 201 transmits/receives job information to/from the print control apparatus 140 via the communication cable. A CPU 202 controls the overall image forming apparatus 100. A RAM 203 is used as a work area when the CPU 202 executes various kinds of commands. A ROM 204 stores a program to be executed by the CPU 202 at the time of activation, various control programs, setting data of the controller 200, and the like. An engine I/F unit 206 instructs the printer unit 210 to execute printing. A communication I/F unit 207 communicates with the inspection apparatus 110 and the finisher 120. The above-described units are connected via an internal bus (system bus) 208. A video I/F unit 209 receives bitmap data from the print control apparatus 140 via the communication cable for image data.

The CPU 202 interprets the bitmap data and the job information received from the print control apparatus 140, and instructs, via the engine I/F unit 206, the printer unit 210 to execute printing. The printer unit 210 prints an image on a print sheet based on the print instruction. For example, if the job information includes an instruction to execute printing by coated paper, the CPU 202 controls to instruct the printer unit 210 to feed a coated paper sheet from a sheet deck of the image forming apparatus 100, that stores coated paper sheets, and execute printing.

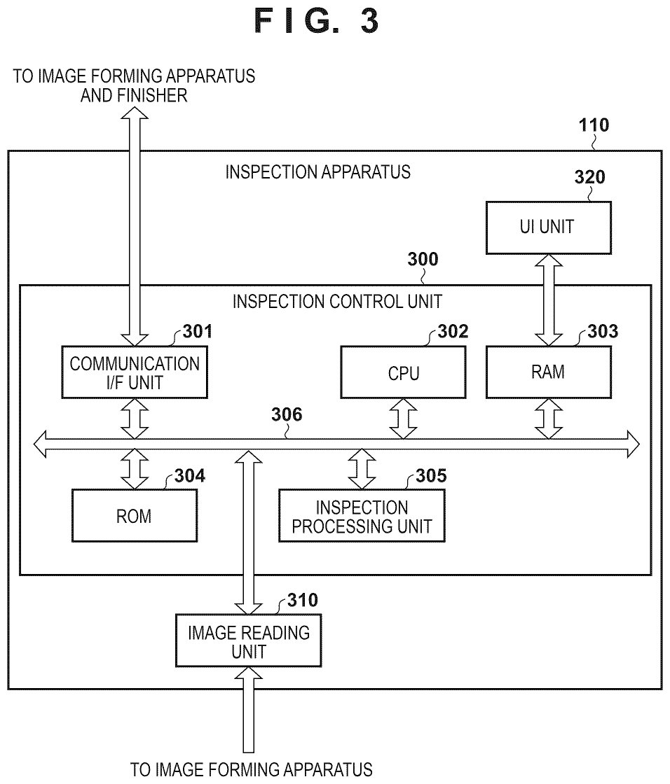

FIG. 3 is a block diagram for explaining a configuration of the inspection apparatus 110 according to the first embodiment.

An inspection control unit 300 controls the overall inspection apparatus 110 and inspects whether a printed material includes a defect. An image reading unit 310 reads a printed material conveyed from the image forming apparatus 100. The image reading unit 310 reads a printed material to generate a scan image. A UI unit 320 provides a user interface for making settings of the inspection apparatus 110 by the user and displaying inspection results to the user. Note that the settings of the inspection apparatus 110 made by the user include an inspection item indicating a defect to be inspected when inspecting a printed material. The inspection item includes, for example, inspection of the presence/absence of an image defect such as a circular defect (spot) or a linear defect (streak). The inspection apparatus 110 includes the above-described inspection control unit 300, image reading unit 310, and UI unit 320. Note that in the first embodiment, the UI unit 320 includes a display unit that displays a screen and a display control unit that controls a screen to be displayed on the display unit. Note also that the UI unit 320 may have a touch panel function.

The configuration of the inspection control unit 300 will be described next. A communication I/F unit 301 transmits/receives data to/from the image forming apparatus 100 and the finisher 120. A CPU 302 controls the overall inspection apparatus 110. A RAM 303 functions as a work area when the CPU 302 executes various kinds of commands. A ROM 304 stores a program to be executed by the CPU 302 at the time of activation, programs and setting data of the inspection control unit 300, and the like. An inspection processing unit 305 inspects whether a printed material includes a defect. The above-described units are connected via an internal bus (system bus) 306. Note that the function of the inspection processing unit 305 may be implemented when the CPU 302 deploys a program stored in the ROM 304 to the RAM 303 and executes it.

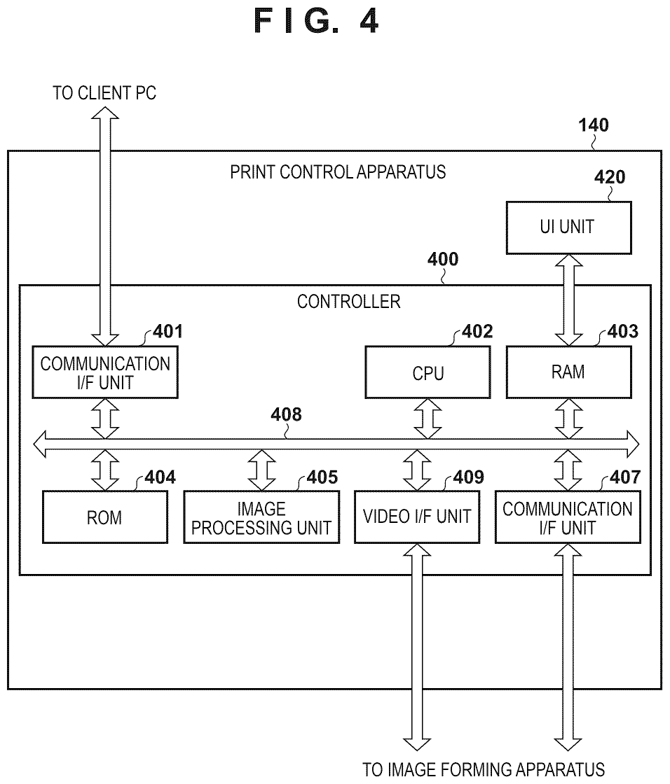

FIG. 4 is a block diagram for explaining a configuration of the print control apparatus 140 according to the first embodiment.

A controller 400 receives image data or document data from the client PC 130, and performs Raster Image Processor (RIP) processing of rasterizing the image data or document data into raster data. A UI unit 420 displays a screen, and accepts an instruction such as a print job setting change instruction from the user. The print control apparatus 140 includes the above-described controller 400 and UI unit 420.

The configuration of the controller 400 will be described next. A communication I/F unit 401 receives image data or document data via the network 150. A CPU 402 controls the overall print control apparatus 140. A RAM 403 functions as a work area when the CPU 402 executes various kinds of commands. A ROM 404 stores a program to be executed by the CPU 402 at the time of activation, programs and setting data of the controller 400, and the like. An image processing unit 405 performs RIP processing for converting the image data or document data received from the client PC 130 into print data. A communication I/F unit 407 transmits/receives data to/from the image forming apparatus 100 via a communication cable. The above-described units are connected via an internal bus (system bus) 408. A video I/F unit 409 transmits image data to the image forming apparatus 100 via the communication cable for image data.

The image data created on the client PC 130 is transmitted as PDL data to the print control apparatus 140, and the PDL data received by the communication I/F unit 401 is saved in the RAM 403. The image processing unit 405 obtains the PDL data saved in the RAM 403, and performs image processing of converting the PDL data into print data. The image processing of converting the PDL data into print data is, for example, processing of rasterizing the PDL data to be converted into multivalued bitmap data, and performing screen processing and the like to convert the multivalued bitmap data into binary bitmap data. The binary bitmap data obtained by the image processing unit 405 is transmitted to the image forming apparatus 100 via the video I/F unit 409. In the PDL data, information (to be referred to as job information hereinafter) concerning contents of a print job including the number of copies and imposition information of single-sided or double-sided printing is transmitted to the image forming apparatus 100 via the communication I/F unit 407. Note that the function of the image processing unit 405 may be implemented when the CPU 402 deploys a program stored in the ROM 404 to the RAM 403 and executes it.

FIG. 10 depicts a schematic sectional view for explaining the configuration of the image forming apparatus 100, the inspection apparatus 110, and the finisher 120 (large capacity stacker) according to the first embodiment.

The image forming apparatus 100 accepts a user input via the UI unit 220 and displays the state of printing or the apparatus. Sheet decks 430 and 431 can store various types of sheets. Each sheet deck can separate only one sheet at the uppermost position among the stored sheets and convey it to a sheet conveyance path 1005. To form a color image, development stations 1001 to 1004 form toner images using color toners of Y, M, C, and K, respectively. The toner images formed here are primarily transferred to an intermediate transfer belt 1006 by superimposing. The intermediate transfer belt 1006 rotates clockwise in FIG. 10, and the superimposed toner image is transferred, at a secondary transfer position 1007, to the sheet conveyed from the sheet conveyance path 1005. A fixing unit 1008 includes a pressurizing roller and a heating roller. When the sheet passes between the rollers, the toner is melted and press-bonded, thereby fixing the toner image on the sheet. The sheet that has passed through the fixing unit 1008 is conveyed to a conveyance path 1012 via a sheet conveyance path 1009. If further melting and press-bonding are necessary for fixing in accordance with the sheet type, the sheet that has passed through the fixing unit 1008 is conveyed to a second fixing unit 1010 via an upper sheet conveyance path. Then, after the sheet undergoes additional melting and press-bonding, the sheet is conveyed to the conveyance path 1012 via a sheet conveyance path 1011. If the image forming mode is a double-sided mode, the sheet having undergone fixing is conveyed to a sheet reversing path 1013. Thus, after the sheet is reversed in the sheet reversing path 1013, the sheet is conveyed to a double-sided conveyance path 1014, thereby performing image transfer to the second side of the sheet at the secondary transfer position 1007.

In the inspection apparatus 110, Contact Image Sensors (CISs) 1015 and 1016 are arranged facing each other. The CISs 1015 and 1016 correspond to the above-described image reading unit 310. The CIS 1015 is a sensor configured to read the upper side of the sheet, and the CIS 1016 is a sensor configured to read the lower side of the sheet. The inspection apparatus 110 scans the sheet using the CISs 1015 and 1016 at a timing when the sheet conveyed to a sheet conveyance path 1017 reaches a predetermined position.

The finisher 120 is a large capacity stacker that can stack a large capacity of sheets. The finisher 120 includes the main tray 1024 as a tray on which sheets are stacked. The sheet that has passed through the inspection apparatus 110 enters the finisher 120 via a sheet conveyance path 1019. The sheet passes through a sheet conveyance path 1022 from the sheet conveyance path 1019, and is stacked on the main tray 1024. Furthermore, the finisher 120 includes the top tray 1020 as a discharge tray. A sheet in which a defect is detected by the inspection apparatus 110 is discharged to the top tray 1020. To discharge a sheet to the top tray 1020, the sheet is conveyed from the sheet conveyance path 1019 to the top tray 1020 via a sheet conveyance path 1021. A reversing unit 1023 for reversing a sheet is used to stack a sheet on the main tray 1024. When stacking a sheet on the main tray 1024, the sheet is reversed once by the reversing unit 1023 such that the direction of the sheet upon stacking becomes the same as the direction of the sheet that enters. When conveying a sheet to the top tray 1020, the sheet is directly discharged without being flipped at the time of stacking, and thus the reversing operation of the sheet by the reversing unit 1023 is not performed.

An outline of printed image inspection performed by the inspection apparatus 110 according to the first embodiment will be described next. The inspection apparatus 110 reads a printed material using the CISs 1015 and 1016 corresponding to the image reading unit 310, thereby obtaining scan image data of the printed material as an inspection target. This scan image data is saved in the RAM 303 of the inspection apparatus 110. Subsequently, the inspection apparatus 110 causes the inspection processing unit 305 to obtain a difference value for each pixel between reference image data (to be referred to as a reference image hereinafter) saved in advance in the RAM 303 and the scan image data (to be referred to as a scan image hereinafter) as the inspection target.

Next, the inspection apparatus 110 performs inspection by comparing the obtained difference values with the inspection threshold (a contrast, a size, or the like) of each inspection item on a pixel basis. If the difference value is smaller than the inspection threshold, inspection is OK (there is no defect); otherwise, inspection is NG (there is a defect). The result of the inspection is saved in the RAM 303. For example, information indicating whether the printed material includes a defect, the type of a detected defect (spot or streak), position information of a defect when it is displayed on the UI unit 320, and the like are saved.

An outline of data inspection performed by the inspection apparatus 110 according to the first embodiment will be described next.

The inspection apparatus 110 reads a printed material using the CISs 1015 and 1016 corresponding to the image reading unit 310, thereby obtaining a scan image of the printed material as an inspection target. This scan image is saved in the RAM 303. Subsequently, the inspection apparatus 110 causes the inspection processing unit 305 to perform inspection of whether a character string or a barcode is legible using a preset character font for optical character recognition (OCR) or the standard for barcodes. It is also possible to perform data collating inspection for performing collation of whether the result of the read character string or barcode matches corresponding data in a correct CSV file prepared in advance. In the data collating inspection, if it is determined that the data match each other, inspection is OK (there is no defect); otherwise, inspection is NG (there is a defect). Furthermore, if the character string or the barcode includes a numerical value and the numerical value regularly changes, the regularity is input to the UI unit 320, thereby making it possible to perform data inspection without the CSV file. This is called the sequential number inspection. The result of the data inspection is saved in the RAM 303. For example, the reading result of the character string or barcode read from the printed material, the result of collation with the correct data, the position information of the read character or barcode when it is displayed on the UI unit 320, and the like are saved.

The CPU 302 of the inspection apparatus 110 instructs the UI unit 320 to display the inspection result saved in the RAM 303. When the inspection result is thus displayed on the UI unit 320, the user can recognize the inspection result.

If a predetermined number of printed materials including defects continuously occur, the CPU 302 of the inspection apparatus 110 transmits information concerning the defects to the image forming apparatus 100 via the communication I/F unit 301.

The controller 200 receives, via the communication I/F unit 207 of the image forming apparatus 100, the information indicating that the printed materials including defects continuously occur. When the controller 200 receives the information, the CPU 202 of the image forming apparatus 100 instructs the printer unit 210 to stop printing. When the printer unit 210 is thus instructed to stop printing, the image forming apparatus 100 stops the print operation.

Furthermore, the CPU 302 of the inspection apparatus 110 transmits information to the finisher 120 via the communication I/F unit 301 based on the inspection result saved in the RAM 303. The information transmitted to the finisher 120 is information indicating whether the printed material includes a defect. Using the received information, the finisher 120 conveys the printed material without any defect to the normal main tray 1024 and stacks it on the main tray 1024, and discharges the printed material including a defect to the top tray 1020.

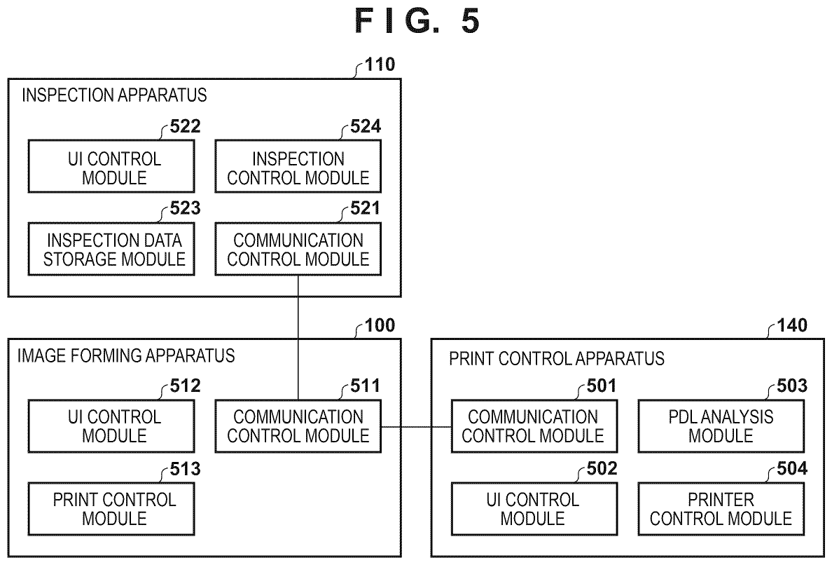

FIG. 5 is a functional block diagram for explaining software components of the inspection apparatus 110, the image forming apparatus 100, and the print control apparatus 140 of the inspection system according to the first embodiment.

The software components (software modules) operating on the print control apparatus 140 will be described first. The functions of the software modules are stored as programs in the ROM 404, and are implemented when the CPU 402 deploys the programs to the RAM 403 and executes them. A communication control module 501 performs communication control with another device. A UI control module 502 controls contents displayed on the UI unit 420, and sends a control instruction to another control module or the like based on an instruction accepted by the UI unit 420. A PDL analysis module 503 analyzes the PDL data received from the client PC 130, and performs RIP processing and generation of job information. A printer control module 504 generates, based on the RIP image and job information generated by the PDL analysis module 503, an instruction to control the image forming apparatus 100. The thus generated instruction is transmitted to the image forming apparatus 100 via the communication control module 501.

The software components operating on the image forming apparatus 100 will be described next. The functions of the software modules are stored as programs in the ROM 204, and are implemented when the CPU 202 deploys the programs to the RAM 203 and executes them. A communication control module 511 performs communication control with another device. A UI control module 512 controls contents displayed on the UI unit 220, and sends a control instruction to another control module based on an instruction accepted by the UI unit 220. A print control module 513 executes a print job in response to a request from the print control apparatus 140.

The software components operating on the inspection apparatus 110 will be described next. The functions of the software modules are stored as programs in the ROM 304, and are implemented when the CPU 302 deploys the programs to the RAM 303 and executes them. A communication control module 521 performs communication control with another device. A UI control module 522 controls contents displayed on the UI unit 320, and sends a control instruction to another control module or the like based on an instruction accepted by the UI unit 320. An inspection data storage module 523 stores, in the RAM 303 or a storage unit (not shown), information associated with inspection, such as settings necessary for inspection, a reference image, and an inspection result. An inspection control module 524 executes control necessary for inspection, such as inspection settings accepted from the UI control module 522, registration of a reference image, and comparison of the reference image and an inspection image (scan image).

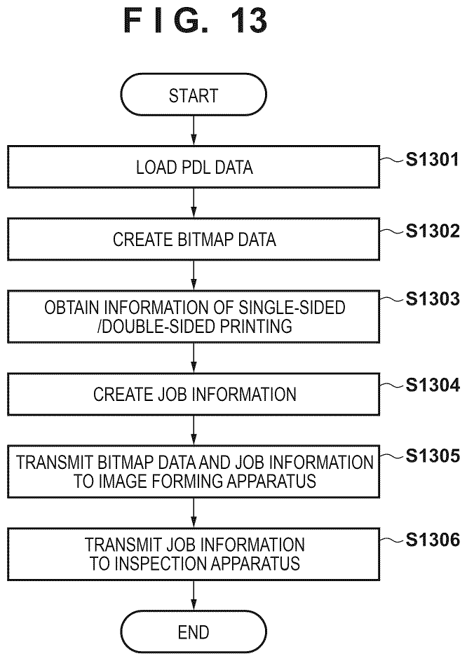

FIG. 13 is a flowchart for explaining processing of creating print data by the print control apparatus 140 and inputting a job to the image forming apparatus 100 and the inspection apparatus 110 according to the first embodiment. Note that processes shown in this flowchart are implemented when the CPU 402 of the print control apparatus 140 deploys program codes stored in the ROM 404 to the RAM 403 and executes them.

In step S1301, the CPU 402 functions as the PDL analysis module 503 to load PDL data received from the client PC 130. The process advances to step S1302, and the CPU 402 functions as the PDL analysis module 503 to create, from the PDL data, bitmap data for printing in the image forming apparatus 100. The process advances to step S1303, and the CPU 402 functions as the PDL analysis module 503 to obtain imposition information of single-sided or double-sided printing from the PDL data. Then, the process advances to step S1304, and the CPU 402 functions as the PDL analysis module 503 to obtain, by performing analysis, information other than the information of single-sided or double-sided printing obtained in step S1303 and to save the information as job information by including the imposition information obtained in step S1303. The process advances to step S1305, and the CPU 402 functions as the printer control module 504 to cause the communication control module 501 to transmit the bitmap data and the job information respectively generated in steps S1302 and S1304 to the image forming apparatus 100. Then, in step S1306, the CPU 402 functions as the printer control module 504 to transmit the job information generated in step S1304 to the inspection apparatus 110 via the image forming apparatus 100.

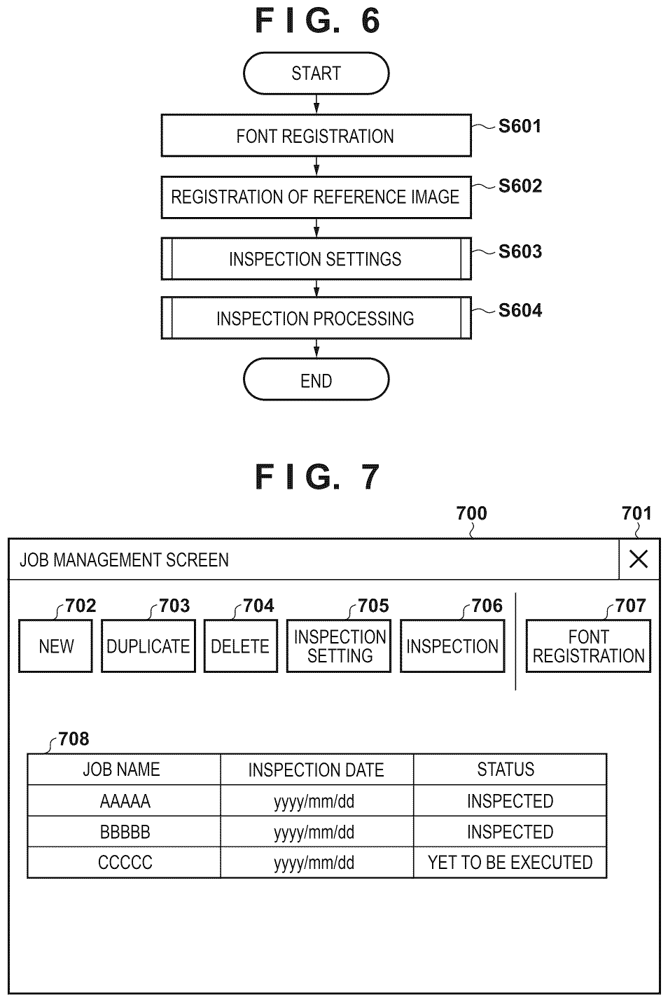

FIG. 6 is a flowchart for explaining procedure of overall processing from a registration operation before the start of inspection to execution of inspection in the inspection apparatus 110 according to the first embodiment. Processes shown in this flowchart are implemented when the CPU 302 of the inspection apparatus 110 deploys program codes stored in the ROM 304 to the RAM 303 and executes them.

In step S601, the CPU 302 functions as the inspection control module 524 to register a character font. The registered character font is used for the data inspection. The character font is font data obtained by associating, with a character code, the character image of a character necessary for optical character recognition (OCR) executed at the time of data inspection. The registered character font is stored by the inspection data storage module 523.

As the registration procedure of the character font, first, the inspection apparatus 110 stands by in a character font image loading mode, and receives a print job for character font creation from the client PC 130. Upon receiving the print job for character font creation from the client PC 130, the inspection apparatus 110 loads a character font image. More specifically, if the image forming apparatus 100 executes printing in accordance with the print job, the inspection apparatus 110 detects a printed material printed and discharged, causes the image reading unit 310 to scan the printed material, and saves the scan image in the RAM 303 of the inspection apparatus 110. Next, the inspection apparatus 110 can extract characters to undergo OCR one by one from the scan image, and create the character font by inputting the character code corresponding to the extracted character image by the user. The thus created character font is saved in the RAM 303 of the inspection apparatus 110. The method of creating the character font according to the first embodiment has been explained but the present invention is not limited to this, and any method capable of creating data by associating a character code with each character image extracted from the scan image may be adopted. Note that only printed image inspection may be performed without performing the data inspection in inspection. In this case, the process shifts to step S602 without performing step S601.

In step S602, the CPU 302 functioning as the inspection control module 524 registers a reference image as a correct image of inspection. At this time, the inspection apparatus 110 stands by in a reference image loading mode, and the image forming apparatus 100 executes a print job for reference image registration from the client PC 130. Upon executing printing, the inspection apparatus 110 detects conveyance of a printed material from the image forming apparatus 100, causes the image reading unit 310 to scan the printed material, and saves the scan image as a reference image in the RAM 303 of the inspection apparatus 110.

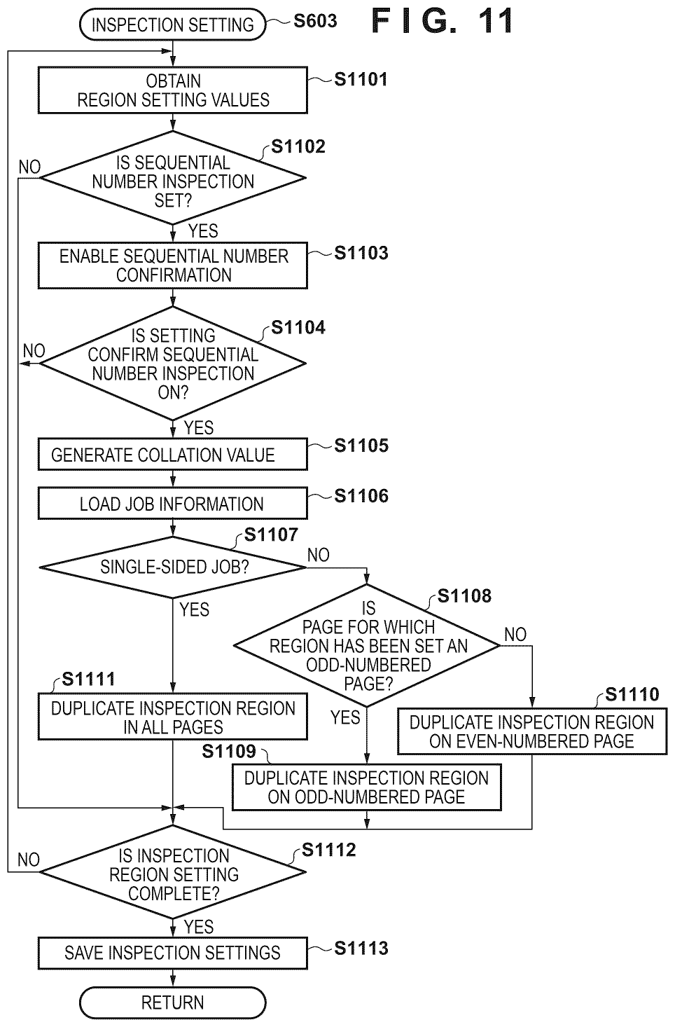

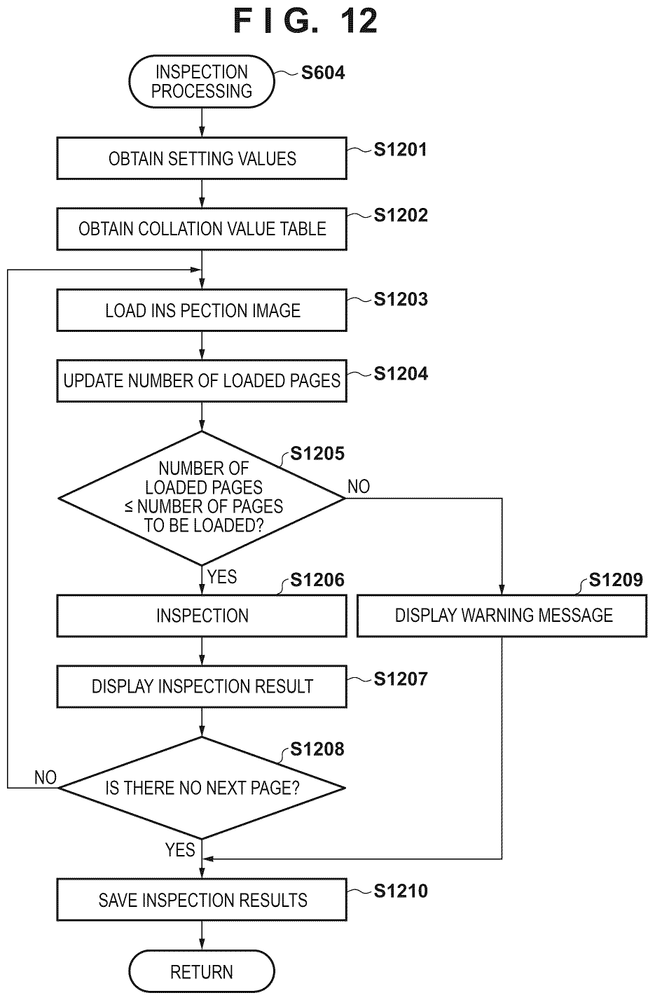

Next, the process advances to step S603, and the CPU 302 functions as the inspection control module 524 to save, in the RAM 303 of the inspection apparatus 110, various kinds of inspection setting values such as an inspection region and an inspection level in accordance with the inspection settings made by the user. Note that details of the processing in step S603 will be described later with reference to a flowchart shown in FIG. 11. Next, the process advances to step S604, and the CPU 302 functions as the inspection control module 524 to receive a print job for inspection from the client PC 130 and detects conveyance of a printed material printed and discharged by the image forming apparatus 100. Then, the image reading unit 310 reads the printed material, and the scan image is saved in the RAM 303 of the inspection apparatus 110. Then, the scan image is compared with the reference image, and inspection is performed using the inspection setting values set in step S603, thereby ending the processing. Note that details of the inspection processing in step S604 will be described later with reference to a flowchart shown in FIG. 12.

FIG. 7 depicts a view showing an example of a job management screen 700 displayed on the UI unit 320 of the inspection apparatus 110 according to the first embodiment.

The job management screen 700 is displayed at the time of activation of the inspection apparatus 110. Alternatively, the job management screen 700 is displayed when an application is activated by a user operation on the UI unit 320. It is possible to perform transition from the job management screen 700 to each of a font registration step, a reference image registration step, an inspection setting step, and an inspection step.

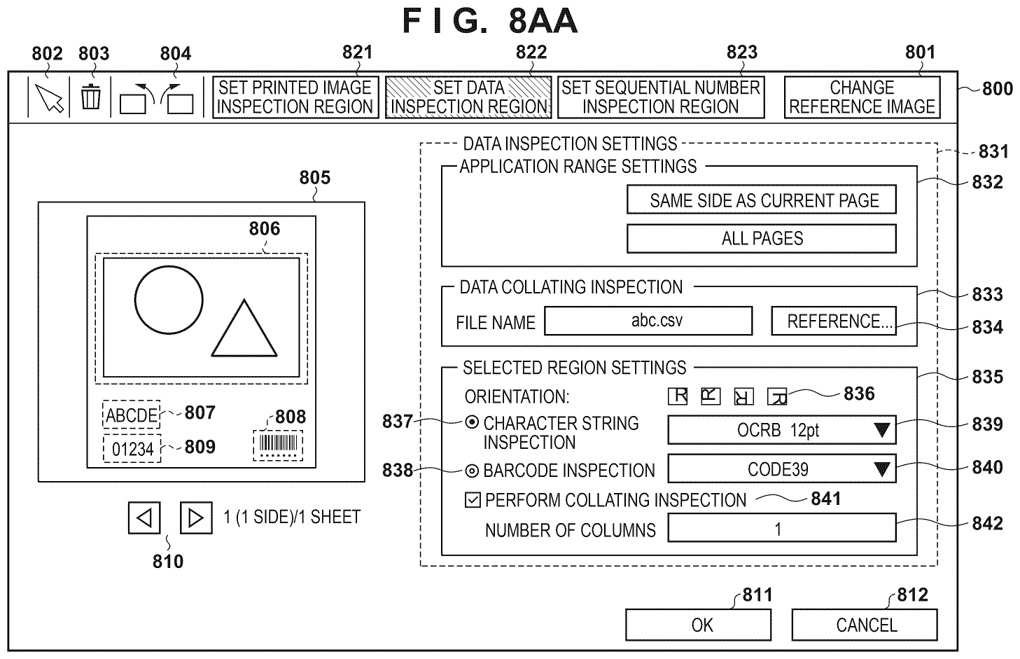

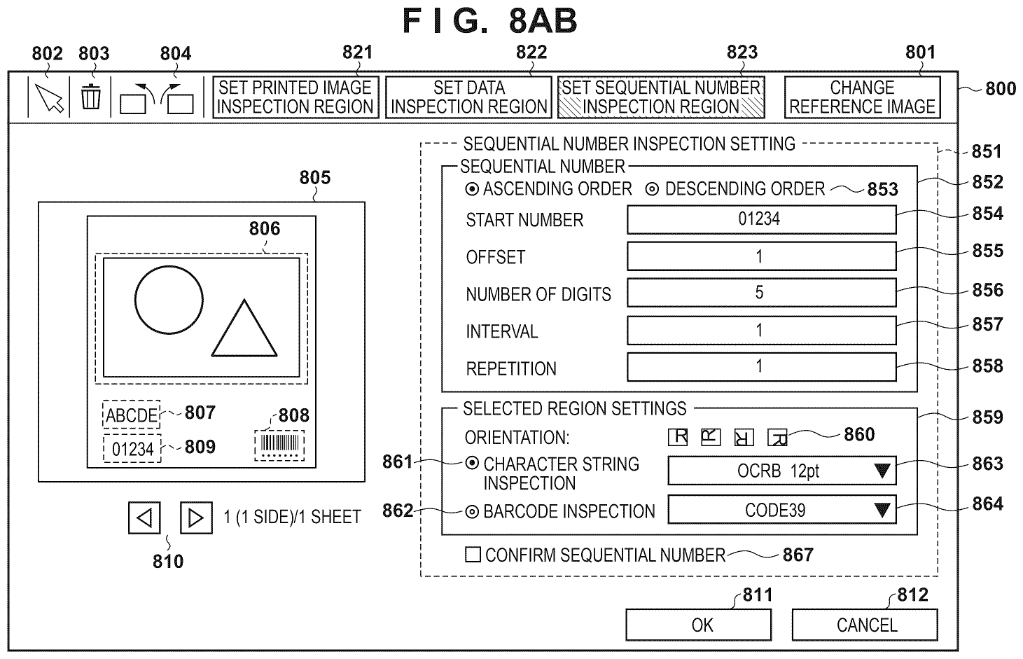

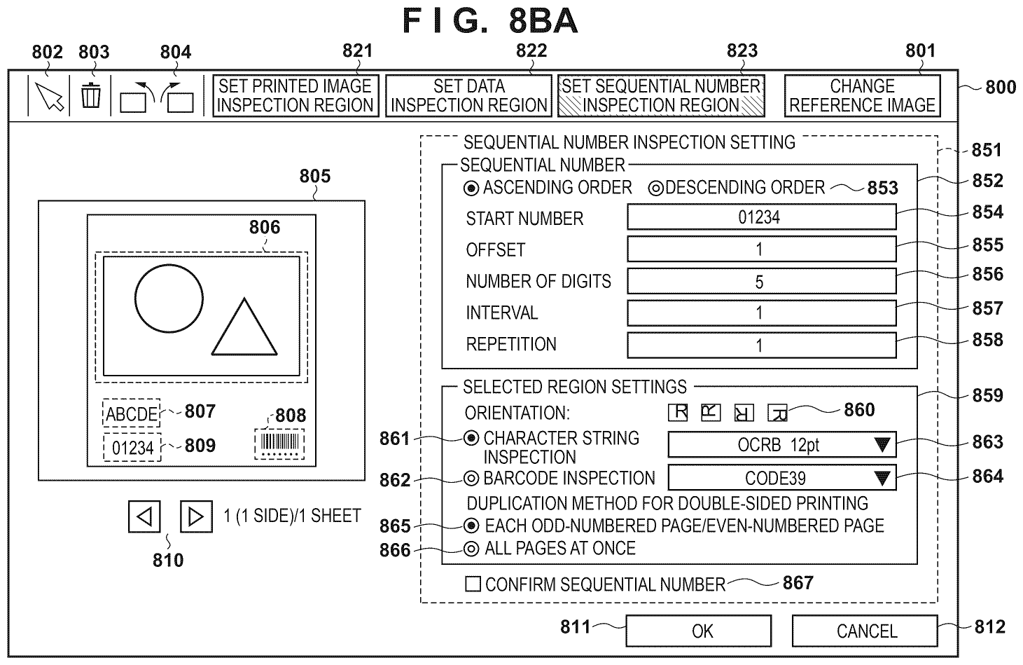

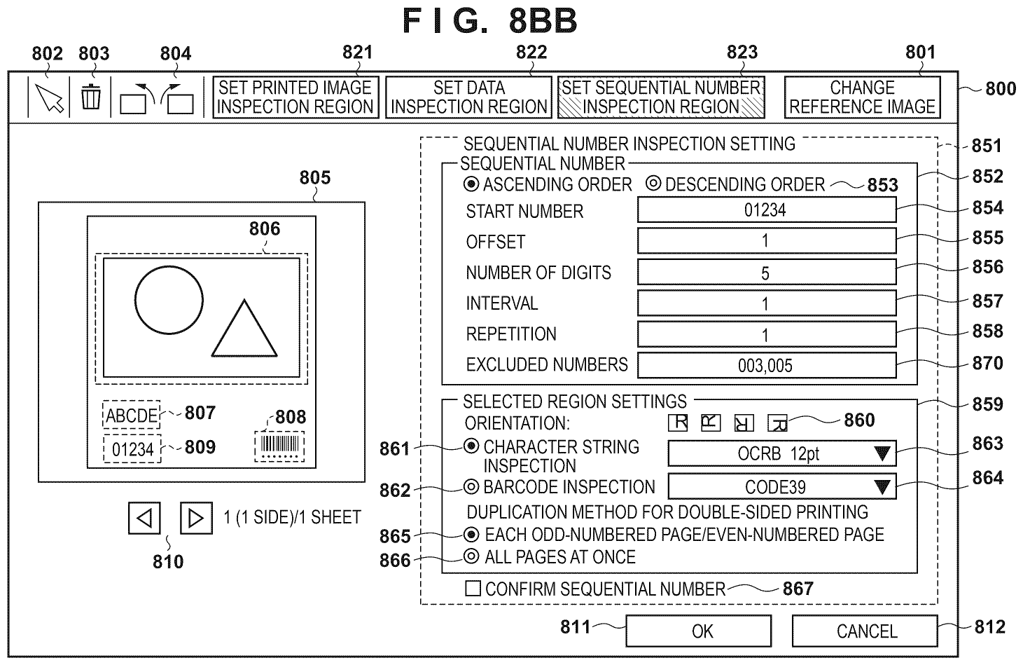

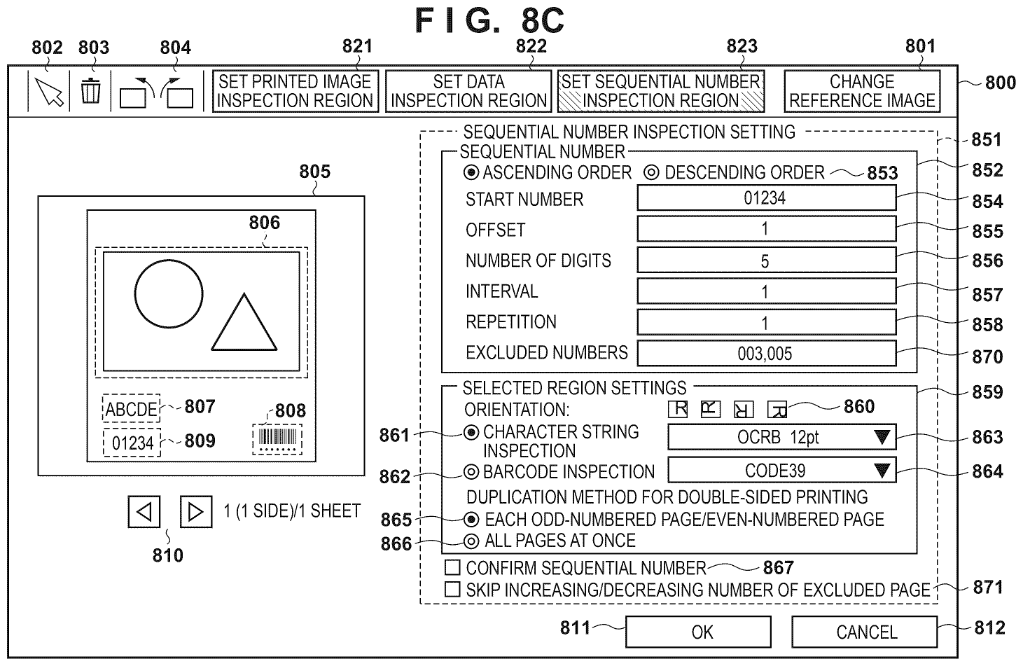

A close button 701 is a button used to end the display of the job management screen 700. A new button 702 is a button used to newly create an inspection job, and a reference image is registered upon the pressing of the new button 702. A duplicate button 703 is a button used to duplicate an already created inspection job. If the duplicate button 703 is pressed in a state in which a desired inspection job is selected from an inspection job list 708, the selected inspection job is duplicated. By perform duplication in this way, it is possible to duplicate the reference image and the inspection settings, and newly perform inspection. A delete button 704 is used to delete an inspection job selected from the inspection job list 708. In this example, by pressing the delete button 704 in a state in which a plurality of inspection jobs are selected, it is possible to simultaneously delete the plurality of inspection jobs. If an inspection setting button 705 is pressed, the control transitions to, for example, an inspection setting screen 800 shown in FIG. 8AA, and it is possible to make inspection settings of an inspection job for which registration of a reference image is complete. An inspection button 706 is used to instruct to execute inspection by an inspection job for which registration of a reference image and the inspection setting are complete. A font registration button 707 is used to instruct to register the character font, as described above.

Inspection settings will be described next with reference to FIGS. 8AA to 8C.

FIG. 8AA shows an example of the inspection setting screen 800 displayed on the UI unit 320 of the inspection apparatus 110 for making inspection settings.

A reference image change button 801 is pressed to change a reference image. A button 802 is an inspection region selection button, and is pressed by a user to select an already set inspection region. A button 803 is an inspection region delete button, and is pressed by the user to delete the selected inspection region. Buttons 804 are used to rotate an image displayed in a region 805. The region 805 is a display region where the loaded reference image is displayed. If there are a plurality of sheets to be loaded, the displayed reference image is switched by buttons 810. The front and back sides of a loaded reference image can also be switched by the buttons 810. If an OK button 811 is pressed, contents set in the inspection setting screen 800 are saved, and the control transitions to the job management screen 700 shown in FIG. 7. Alternatively, when the OK button 811 is pressed, the control may transition to an inspection screen (not shown) to make it possible to execute inspection. If a cancel button 812 is pressed, the control transitions to the job management screen 700 shown in FIG. 7 without saving the settings in the inspection setting screen 800.

A printed image inspection region setting button 821 is pressed by the user to newly create a printed image inspection region. After pressing the button 821, the user sets an inspection region for the reference image displayed in the region 805. A region 806 is an example of the set printed image inspection region.

A data inspection region setting button 822 is pressed by the user to newly create a character inspection region or a barcode inspection region. After pressing the button 822, the user sets an inspection region of data inspection for the reference image displayed in the region 805. A region 807 shows a setting example of a character inspection region, and a region 808 shows a setting example of a barcode inspection region.

A sequential number inspection region setting button 823 is pressed by the user to newly create a sequential number inspection region. After pressing the button 823, the user sets an inspection region of sequential number inspection for the reference image displayed in the region 805. A region 809 shows a setting example of a sequential number inspection region.

A data inspection setting region 831 includes a UI group for making settings for the data inspection region displayed when the data inspection region is selected in the region 805. In this example, assume that the currently selected region is the region 807 representing the character inspection region. An application range setting 832 is used to set an application range of the selected region. If no region is selected, the currently selected inspection region is arranged only in a page displayed in the region 805 at this time. As shown in FIG. 8AA, if “same side as current page” is selected, the currently selected inspection region is arranged in a page of the same side in accordance with whether the inspection region currently selected in the region 805 is arranged on the front side or the back side of the sheet. If “all pages” is selected, the currently selected inspection region is arranged in all the pages.

A collating inspection setting region 833 is a region for setting a correct CSV file to be collated when performing collating inspection. A file is selected by pressing a reference button 834 and a selected file name is then displayed. In FIG. 8AA, “abc.csv” is displayed as a file name. The designation of the correct CSV file is common to character inspection and barcode inspection.

In a setting region 835, settings of the currently selected data inspection region are made. In this example, selection of a character orientation, selection of a character region or a barcode region, and designation of a font type, a barcode type, the presence/absence of collating inspection, and a column of the correct CSV file at the time of collating inspection are performed. A setting item 836 sets the character orientation of the character region 807. Setting items 837 and 838 designate whether the currently selected region undergoes character string inspection or barcode inspection. In FIG. 8AA, character string inspection is selected. A setting item 839 sets a font for performing OCR processing of the character region 807. In FIG. 8AA, a font “OCRB” and a size of 12 points are set. A setting item 840 sets a barcode type in a case where barcode inspection is selected in the setting item 838. A setting item 841 sets the presence/absence of execution of collating inspection. If a radio button in the setting item 837 is checked to set the “presence” of collating inspection, OCR processing of the character region 807 is performed using the correct CSV file designated in the collating inspection setting region 833 and the column number designated in a setting item 842. Then, collating inspection of the read character string and a character string designated in the correct CSV file is performed. In FIG. 8AA, the radio button is checked to set the “presence” of collating inspection.

FIG. 8AB depicts a view showing an example of the inspection setting screen when the sequential number inspection region setting button 823 is pressed to set a sequential number inspection region. A description of portions common to FIG. 8AA will be omitted. Assume here that the sequential number inspection region 809 in the region 805 is selected.

A sequential number inspection setting region 851 includes a UI group for making settings for the sequential number inspection region displayed when the sequential number inspection region 809 is selected in the region 805. In a sequential number setting region 852, settings of the currently selected sequential number inspection region are made. In this example, a sequential number rule is set. The sequential number rule includes designation of an ascending order or a descending order, a start number, an offset, the number of digits, an interval, and repetition. A setting item 853 is an item for selecting whether the numerical value of the sequential number increases (ascending order) or decreases (descending order), and the numerical value increases in the case of the ascending order and decreases in the case of the descending order. A setting item 854 is an item for setting the start number of the sequential number. A setting item 855 is an item for setting an increase/decrease value between sheets of sequential number inspection target regions. This is called an offset in the first embodiment. A setting item 856 is an item for setting the number of digits of the sequential number. For 5 digits of “01234” as in the region 809, 5 is designated. The number of digits of the numerical value of the inspection target region need not directly be set. For example, even if the number of digits of the numerical value of the inspection target region is 5, if only 3 digits of the 5 digits are to be inspected, “3” is set. A setting item 857 is an item for setting the number of sheets for which the number is increased or decreased by the offset. If, for example, “2” is set as the interval, the sequential number is increased by the offset (1 in this example) for every two sheets. A setting item 858 sets the number of times the sequential number created by the settings of the setting items 853, 854, 855, 856, and 857 is repeated.

Setting items 860 to 864 included in a setting region 859 have the same meanings as those of the setting items 836 to 840 in the setting region 835 shown in FIG. 8AA and a description thereof will be omitted.

A setting item 867 sets, by a radio button, the presence/absence of inspection by a collation value generated by the sequential number rule set in the sequential number setting region 852. Details of the setting item will be described later with reference to FIG. 11.

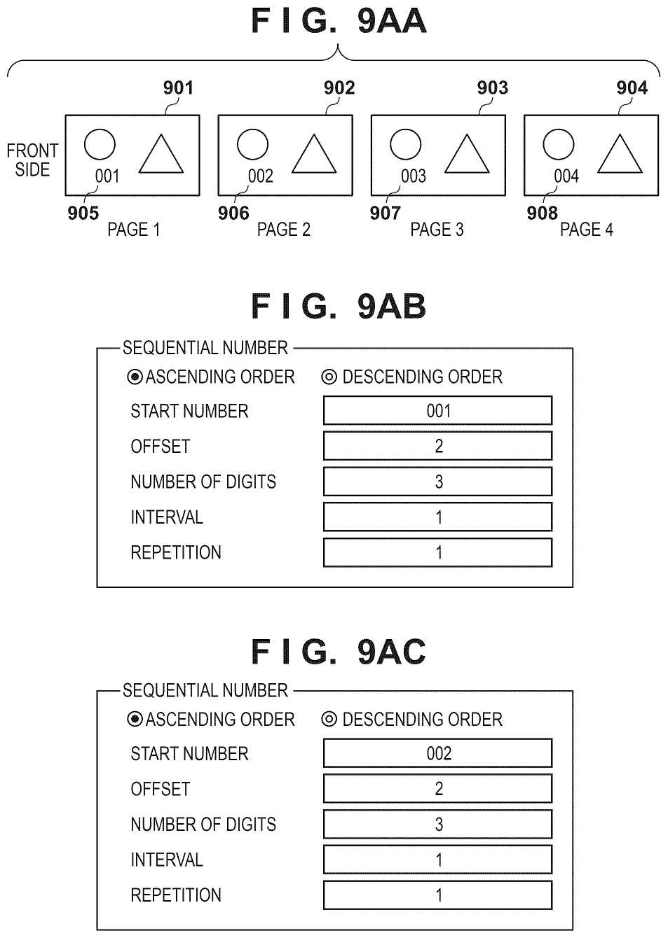

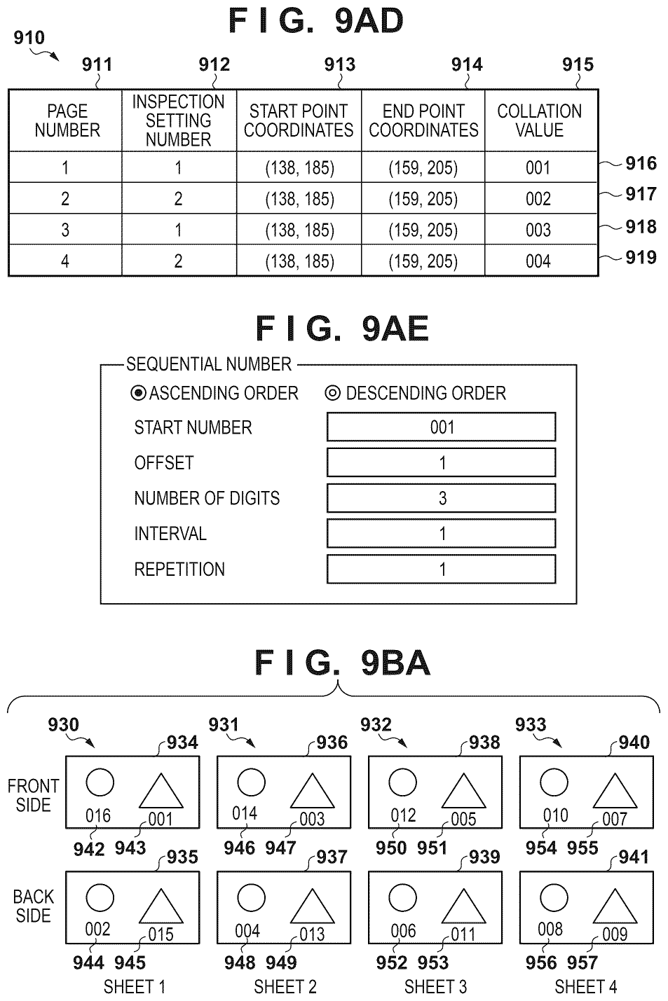

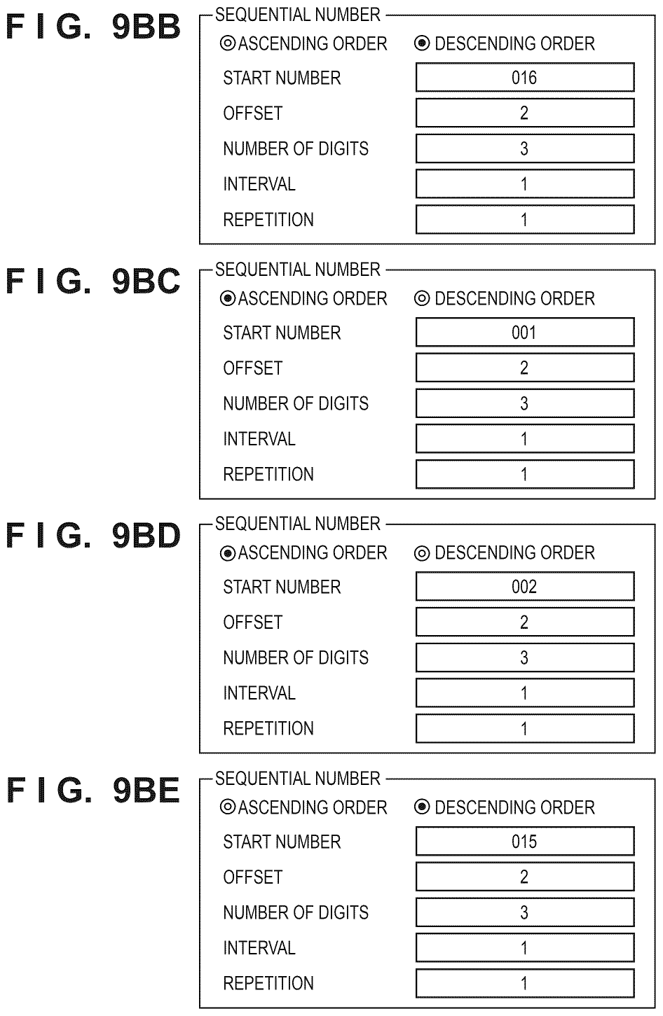

Setting examples of sequential number inspection and collation values will be described next with reference to FIGS. 9AA to 9AE and 9BA to 9BE.

FIG. 9AA shows an example of a correct image (reference image). An image 901 represents page 1, an image 902 represents page 2, an image 903 represents page 3, and an image 904 represents page 4, and the images are sequentially read from page 1. Reference numerals 905 to 908 denote sequential numbers printed on the images 901 to 904, respectively. The user sets sequential number inspection regions for the sequential numbers 905 to 908. In the conventional technique, a method of setting an inspection region for each of the front side and the back side, and reflecting the settings of the front side on odd-numbered pages and the settings of the back side on even-numbered pages is adopted.

With respect to the sequential numbers 905 to 908, FIG. 9AB shows a setting example in a case where the sequential number inspection region of an odd-numbered page is set, and FIG. 9AC shows a setting example in a case where the sequential number inspection region of an even-numbered page is set. The setting example shown in FIG. 9AB will be described first. Since the start number of the sequential number 905 of the odd-numbered page is “001”, the start number is set to “001”. Since the sequential number increases by 2 like “001” for the sequential number 905 of page 1 and “003” for the sequential number 907 of page 3, an offset indicating an increase/decrease number is set to “2”. In addition, since the sequential numbers 905 and 907 of the odd-numbered pages have 3 digits, the number of digits is set to “3”. In the inspection images shown in FIG. 9AA, since the same number is not repeated, an interval is set to “1”. Since the sequential number is not repeated, repetition is set to “1”.

Next, the setting example shown in FIG. 9AC will be described. Since the start number of the sequential number 906 of the even-numbered page is “002”, the start number is set to “002”. Since the sequential number increases by 2 like “002” for the sequential number 906 of page 2 and “004” for the sequential number 908 of page 4, an offset indicating an increase/decrease number is set to “2”. In addition, since the sequential numbers 906 and 908 of the odd-numbered pages have 3 digits, the number of digits is set to “3”. In the inspection images shown in FIG. 9AA, since the same number is not repeated, an interval is set to “1”. Since the sequential number is not repeated, repetition is set to “1”.

FIG. 9AD shows a collation value table 910 generated by the inspection control module 524 by receiving the settings in FIGS. 9AB and 9AC. The collation value table 910 is a table of summarizing collation value information. A page number 911 represents a page number in the correct image shown in FIG. 9AA. An inspection setting number 912 is a number for distinguishing the inspection settings. In the collation value table 910, the settings shown in FIG. 9AB are recorded with inspection setting number 1, and the settings shown in FIG. 9AC are recorded with inspection setting number 2. Start point coordinates 913 and end point coordinates 914 are coordinates representing the inspection regions respectively corresponding to the inspection regions in FIG. 9AA. These are represented by a coordinate system in which the upper left end of the image is set as (0, 0), and a rectangular region obtained by connecting the start point coordinates and the end point coordinates is set as an inspection region. A collation value 915 is a collation value generated from the information of the ascending order/descending order, the start number, the offset, the number of digits, the interval, and the repetition based on the settings shown in FIG. 9AB or 9AC. At the time of sequential number inspection, data collating inspection is performed using the collation value. By the settings for the odd-numbered page shown in FIG. 9AB, a row 916 is generated first. After that, with respect to a row 918 in which the page number is an odd number, “1” of the inspection setting number 912 and the inspection region (the start point coordinates 913 and the end point coordinates 914) are duplicated, and a newly generated collation value (“3”) is recorded in the collation value 915.

Similarly, with respect to the settings for the even-numbered page shown in FIG. 9AC, a row 917 is generated first, and then the inspection region and the like are duplicated with respect to a row 919 in which the page number is an even number and a generated collation value (“4”) is recorded. By setting the sequential number rule in this way, it is possible to generate a collation value based on the rule even if a data file such as a CSV file does not exist. FIG. 9BA shows an example of saddle stitch binding of 16 pages as a case where an inspection region is to be set for each odd-numbered page/even-numbered page in sequential number inspection.

In saddle stitch binding of 16 pages, four sheets denoted by reference numerals 930 to 933 are printed. Each sheet undergoes double-sided printing, front side images are denoted by reference numerals 934, 936, 938, and 940, and back side images are denoted by reference numerals 935, 937, 939, and 941. Page numbers 942 to 957 are arranged in the lower portions of the respective pages of the front side images and the back side images. By focusing on the sequential numbers denoted by reference numerals 942, 946, 950, and 954 arranged in the lower left portions of the front side images, the start number is “016” and the sequential number decreases by the offset “2”. Therefore, the sequential number settings of the front side image are as shown in FIG. 9BB. Similarly, by focusing on the sequential numbers denoted by reference numerals 943, 947, 951, and 955 arranged in the lower right portions of the front side images, the start number is “001” and the sequential number increases by the offset “2”. Therefore, the sequential number settings are as shown in FIG. 9BC.

By focusing on the sequential numbers denoted by reference numerals 944, 948, 952, and 956 arranged in the lower left portions of the back side images, the start number is “002” and the sequential number increases by the offset “2”. Therefore, the sequential number settings are as shown in FIG. 9BD. Similarly, by focusing on the sequential numbers denoted by reference numerals 945, 949, 953, and 957 arranged in the lower right portions of the back side images, the start number is “015” and the sequential number decreases by the offset “2”. Therefore, the sequential number settings are as shown in FIG. 9BE. By comparing FIGS. 9BB to 9BE, the start number and the increase/decrease amount are different even for the identical positions on the front side and the back side, and different inspection settings are necessary for the front side and the back side.

However, if inspection settings are always made for each odd-numbered page/even-numbered page, even in a case where single-sided printing is performed using the correct image shown in FIG. 9AA, it is necessary to make the settings for the odd-numbered page shown in FIG. 9AB and the settings for the even-numbered page shown in FIG. 9AC. To cope with this, the first embodiment will describe a method of making inspection settings for all pages at once in the case of a single-sided print job by using the information of single-sided/double-sided printing.

The inspection setting processing in step S603 of FIG. 6 will be described next with reference to a flowchart shown in FIG. 11.

FIG. 11 is a flowchart for explaining the inspection setting processing in step S603 of FIG. 6 according to the first embodiment. Note that processes shown in this flowchart are implemented when the CPU 302 of the inspection apparatus 110 deploys program codes stored in the ROM 304 to the RAM 303, and reads out and executes the program codes deployed to the RAM 303.

In step S1101, the CPU 302 functions as the inspection control module 524 to obtain the region setting values set by the user. Next, the process advances to step S1102, and the CPU 302 functions as the inspection control module 524 to determine whether the region setting values obtained in step S1101 include a sequential number inspection region. If the sequential number inspection region is included, the process advances to step S1103. If no sequential number inspection region is included, the process advances to step S1112.

In step S1103, the CPU 302 functions as the inspection control module 524 to enable a sequential number confirmation function. In this example, the setting item 867 shown in FIG. 8AB is made settable. That is, in a case where at least one or more sequential number inspection regions are set, the radio button of the setting item 867 can be checked. Then, the process advances to step S1104, and the CPU 302 determines whether the setting item 867 has been set to confirm the sequential number. That is, it is determined whether the radio button of the setting item 867 shown in FIG. 8AB has been checked. If it is determined that the radio button of the setting item 867 has been checked to confirm the sequential number, the process advances to step S1105. If it is determined that the radio button of the setting item 867 has not been checked not to confirm the sequential number, the process advances to step S1112.

In step S1105, the CPU 302 functions as the inspection control module 524 to generate collation values from the sequential number inspection region setting values. This collation values are generated by increasing/decreasing the start number input to the setting item 854 (start number) by the offset of the setting item 855. At this time, whether to increase or decrease the start number by the offset is determined based on the setting item 853 (ascending order or descending order). Next, the process advances to step S1106, and the CPU 302 functions as the inspection control module 524 to load the job information transmitted from the print control apparatus 140. Then, the process advances to step S1107, and the CPU 302 functions as the inspection control module 524 to extract the imposition information of single-sided or double-sided printing from the job information loaded in step S1106 and determine whether the job is a single-sided print job. If the job is a single-sided print job, the process advances to step S1111. If the job is a double-sided print job, the process advances to step S1108.

In step S1108, the CPU 302 functions as the inspection control module 524 to determine whether pages for which the region has been set are odd-numbered pages. If it is determined that the pages are odd-numbered pages, the process advances to step S1109. If it is determined that the pages are even-numbered pages, the process advances to step S1110. In step S1109, the CPU 302 functions as the inspection control module 524 to duplicate the inspection region on the odd-numbered pages. At this time, on the collation value table 910, the inspection setting number 912 and the inspection region (the start point coordinates 913 and the end point coordinates 914) are duplicated with respect to the odd-numbered pages, and the collation values generated in step S1105 are recorded in the collation value 915. On the other hand, in step S1110, the CPU 302 functions as the inspection control module 524 to duplicate the inspection region on even-numbered pages. At this time, on the collation value table 910, the inspection setting number 912 and the inspection region (the start point coordinates 913 and the end point coordinates 914) are duplicated with respect to the even-numbered pages, and the collation values generated in step S1105 are recorded in the collation value 915. As described above, in the case of double-sided print job, the collation value table 910 shown in FIG. 9D is generated by making the settings for the odd-numbered pages shown in FIG. 9AB and the settings for the even-numbered pages shown in FIG. 9AC.

In the case of the single-sided print job, in step S1111, the CPU 302 functions as the inspection control module 524 to duplicate the inspection region in all the pages. In this case, on the collation value table 910, the inspection setting number 912 and the inspection region (the start point coordinates 913 and the end point coordinates 914) are duplicated with respect to all the pages, and the collation value generated in step S1105 is recorded in the collation value 915. Thus, in the case of the single-sided print job, the collation value table 910 can be generated only by the settings shown in FIG. 9AE.

In step S1112, the CPU 302 functions as the UI control module 522 to determine whether the inspection region setting is complete. At this time, it is determined whether the OK button 811 shown in FIG. 8AB has been pressed. If the OK button 811 has been pressed, it is determined that the inspection setting is complete, and the process advances to step S1113. If the OK button 811 has not been pressed, the process returns to step S1101, and the CPU 302 stands by for the inspection region setting. In this way, in step S1113, the CPU 302 functions as the inspection control module 524 to save the setting values set in the inspection setting screen and the collation value table 910 in the RAM 303, thereby ending the inspection setting processing.

The inspection processing in step S604 of FIG. 6 will be described next with reference to a flowchart shown in FIG. 12.

FIG. 12 is a flowchart for explaining the inspection processing in step S604 of FIG. 6 according to the first embodiment. Note that processes shown in this flowchart are implemented when the CPU 302 of the inspection apparatus 110 deploys program codes stored in the ROM 304 to the RAM 303, and reads out and executes the program codes deployed to the RAM 303.

In step S1201, the CPU 302 functions as the inspection control module 524 to obtain the inspection setting values saved in the RAM 303. Next, the process advances to step S1202, and the CPU 302 functions as the inspection control module 524 to obtain the collation value table 910 saved in the RAM 303. Next, the process advances to step S1203, and the CPU 302 functions as the inspection control module 524 to load a scan image (inspection image). At this time, conveyance of a sheet is detected, the sheet is scanned by the image reading unit 310, and the scan image is saved in the RAM 303 of the inspection apparatus 110. Then, the process advances to step S1204, and the CPU 302 functions as the inspection control module 524 to update the number of loaded pages. In this example, the number of pages is incremented by one every time one page is read. The process advances to step S1205, and the CPU 302 functions as the inspection control module 524 to determine whether the number of read pages exceeds the number of pages to be read. Assume that the number of pages to be read is preset in a setting screen (not shown) by the user. Alternatively, the number of pages to be read may be received as job information for inspection from the print control apparatus 140. If it is determined that the number of pages to be read is not exceeded, the process advances to step S1206. If the number of pages to be read is exceeded, the process advances to step S1209.

In step S1206, the CPU 302 functions as the inspection control module 524 to perform OCR processing for the sequential number inspection region based on the collation value loaded in step S1202 and the scan image loaded in step S1203 and perform collating inspection with the recognized character string. At this time, in sequential number inspection, the collation value corresponding to the number of pages updated in step S1204 is read out from the collation value table 910 to perform collation. If a printed image inspection region is set, the reference image and the scan image are compared to detect an image defect such as stains. If a data inspection region is set, data legibility inspection and data collating inspection of the data inspection region is performed in accordance with the inspection settings. After the inspection thus ends, the process advances to step S1207, and the CPU 302 functions as the UI control module 522 to display the inspection results on the UI unit 320, and then the process advances to step S1208. In step S1208, the CPU 302 functions as the inspection control module 524 to determine the presence/absence of the next page to be read. If the next page is to be read, the process returns to step S1203 to read the next page. On the other hand, if the next page is not to be read, the process advances to step S1210.

If the CPU 302 determines in step S1205 that the number of pages to be read is exceeded, the process advances to step S1209, and the CPU 302 functions as the UI control module 522 to display, on the UI unit 320, a message screen indicating that the pages have been read to exceed the number of pages to be read, and then the process advances to step S1210. In step S1210, the CPU 302 saves the inspection results in the RAM 303, thereby ending this inspection.

As described above, according to the first embodiment, in the case of a single-sided print job, inspection settings are duplicated with respect to all the pages, and the sequential number of each page is compared with a generated collation value, thereby making it possible to perform data collating inspection. In this way, it is possible to provide an inspection system capable of setting the inspection region for all the pages at once in the single-sided print job.

### Second Embodiment

The above-described first embodiment has explained a method of automatically switching, based on the information of single-sided/double-sided printing of the job information, the inspection region duplication method between “each odd-numbered page/even-numbered page” and “all pages at once” in sequential number inspection. However, in the method according to the first embodiment, the duplication method is forcibly determined only based on the job information regardless of the sequential number regularity. Therefore, even if it is desirable to make inspection settings for all the pages at once in a double-sided print job, the method of “duplication for each odd-numbered page/even-numbered page” is determined, and it is necessary to make settings for each odd-numbered page/even-numbered page.

To cope with this, in a second embodiment, a method that makes it possible to select an inspection region duplication method in the case of a double-sided print job will be described. In the second embodiment, portions different from the above-described first embodiment will be described below. Note that portions not described in detail are the same as in the first embodiment.

FIG. 8BA depicts a view showing an example of an inspection setting screen in a case where a currently selected setting region is a sequential number inspection region in an inspection apparatus 110 according to the second embodiment. Portions common to FIG. 8AB described above are denoted by the same reference numerals and a description thereof will be omitted.

Buttons 865 and 866 are buttons for selecting an inspection region duplication method at the time of a double-sided print job. When the button 865 is selected, an inspection region is duplicated by the method of “each odd-numbered page/even-numbered page” that is the same as in the first embodiment. On the other hand, when the button 866 is selected, an inspection region is duplicated by the method of “all pages at once”. The buttons 865 and 866 may be grayed out or may not be displayed in the case of a single-sided print job. The method selected by the button 865 or 866 is saved as a region setting value in the RAM 303.

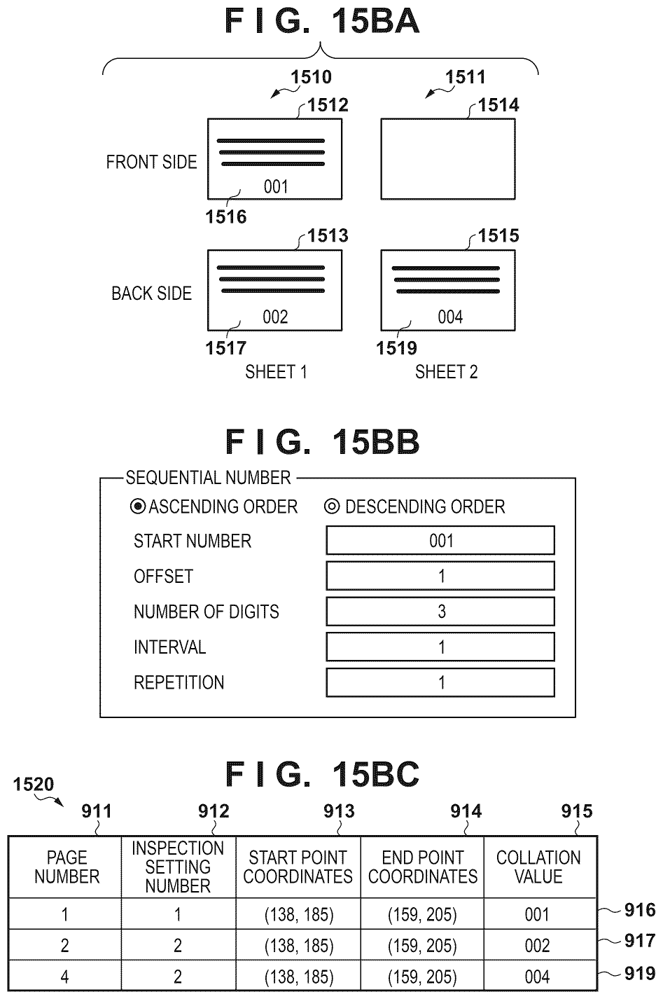

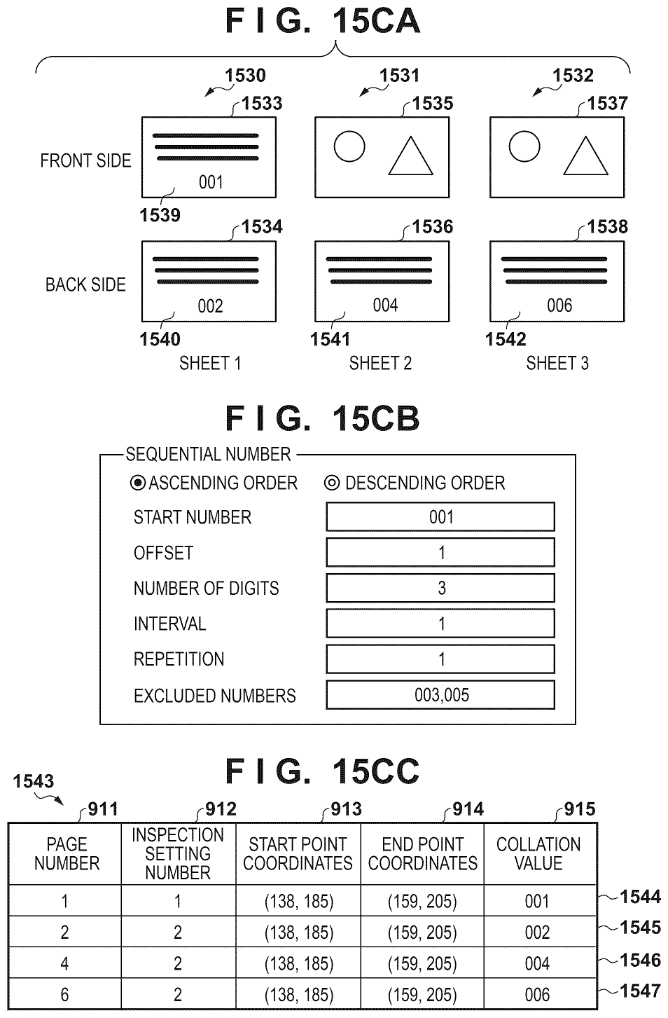

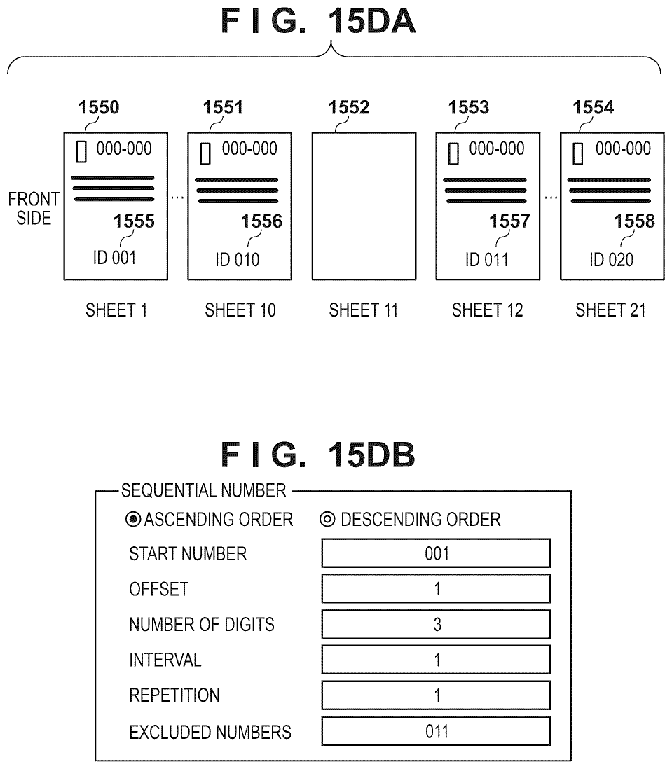

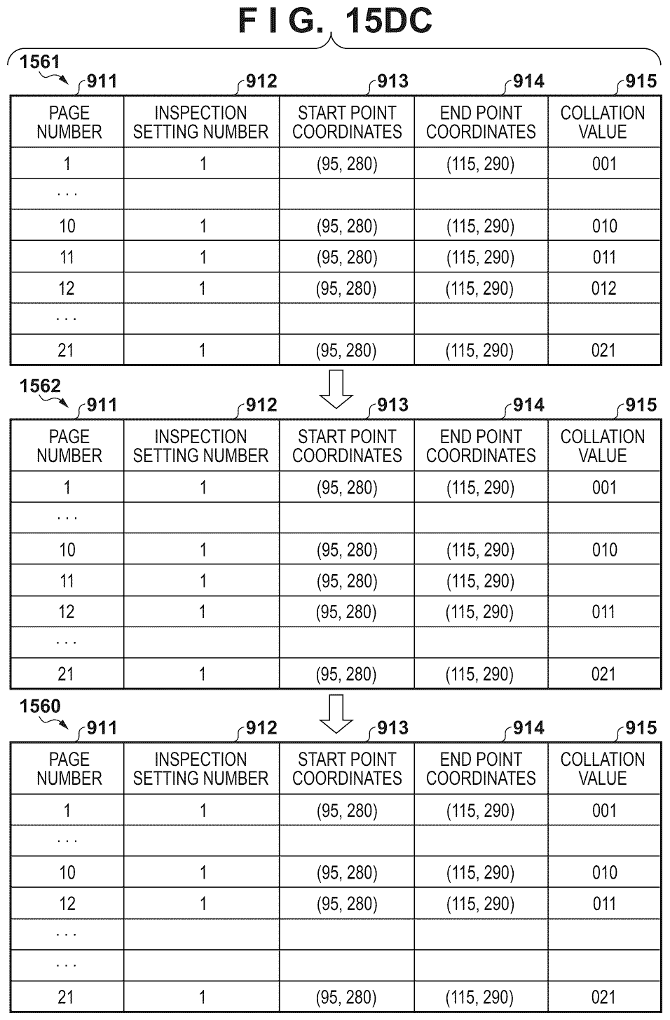

FIGS. 15AA to 15AC depict views showing examples of data for which inspection settings are to be made for all pages at once, sequential number settings, and a collation value table 910 in a double-sided print job according to the second embodiment.

FIG. 15AA shows an example of data for which inspection settings are to be made for all pages at once. In FIG. 15AA, two sheets denoted by reference numerals 1500 and 1501 are printed. Each sheet undergoes double-sided printing, front side images are denoted by reference numerals 1502 and 1504, and back side images are denoted by reference numerals 1503 and 1505. Page numbers 1506 to 1509 are arranged in the lower portions of the respective pages. The page number has a start number “001” and increases by an offset “1”. Therefore, in this case, the sequential number settings are as shown in FIG. 15AB. Then, if the sequential numbers with the same start number and the equal increase/decrease amount are arranged at the identical positions on the front side/back side, the inspection settings are desirably made for all the pages at once even in a double-sided print job.

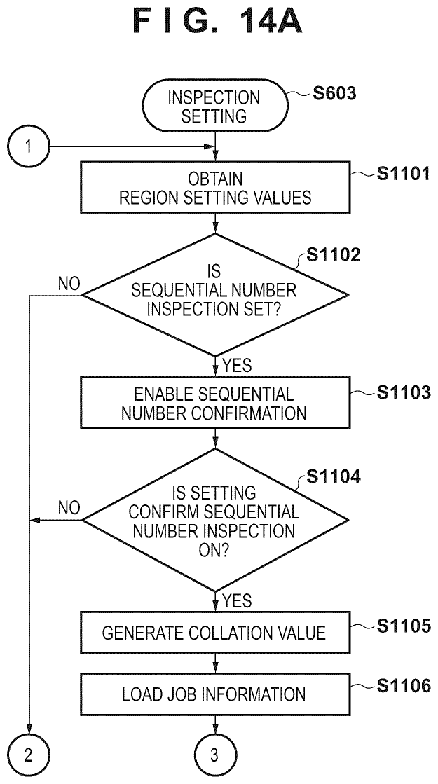

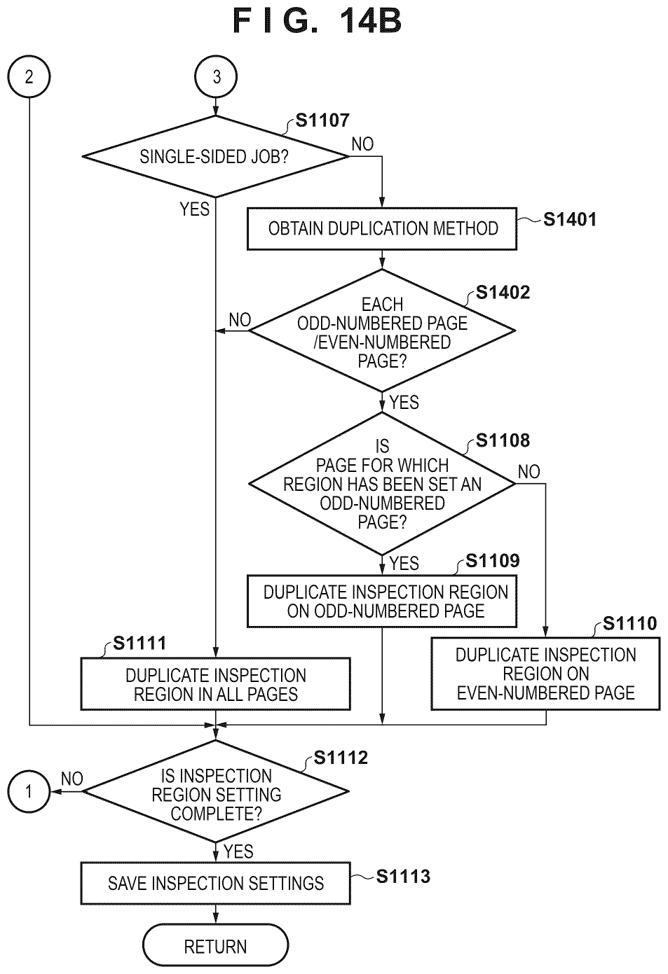

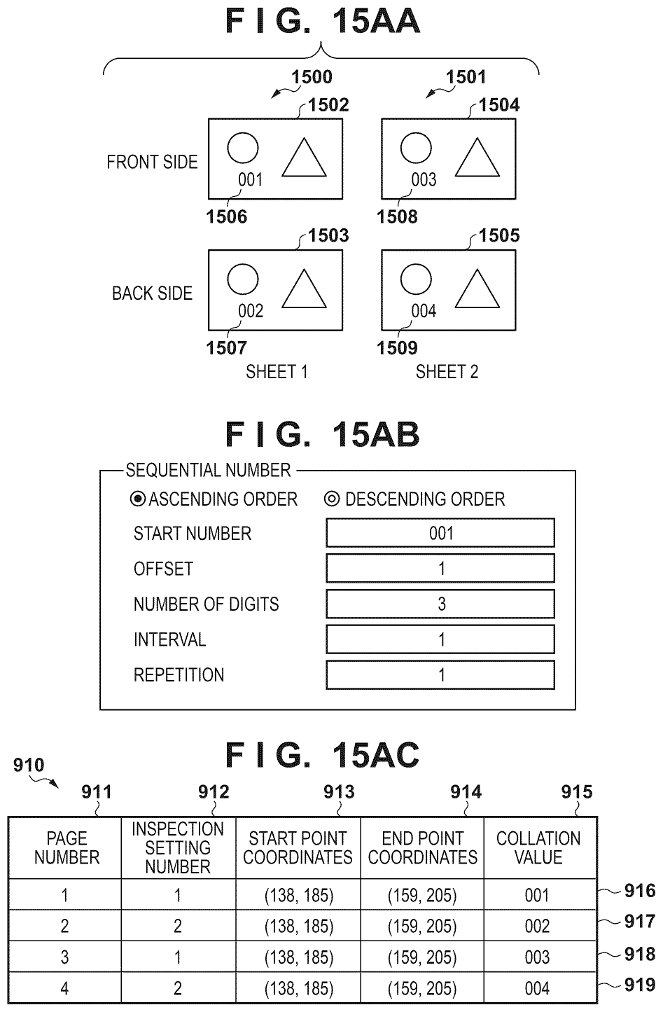

FIGS. 14A and 14B are flowcharts for explaining inspection setting processing in step S603 according to the second embodiment. Note that in FIGS. 14A and 14B, the same reference symbols as in FIG. 11 according to the above-described first embodiment denote the same processes and a description thereof will be omitted. Note that processes shown in this flowchart are implemented when the CPU 302 of the inspection apparatus 110 deploys program codes stored in the ROM 304 to the RAM 303, and reads out and executes the program codes deployed to the RAM 303.

If it is determined in step S1107 that a job is not a single-sided print job, the process advances to step S1401, and the CPU 302 functions as the inspection control module 524 to obtain a duplication method from the region setting values obtained in step S1101. Then, the process advances to step S1402, and the CPU 302 functions as the inspection control module 524 to determine whether the duplication method obtained in step S1101 is the method of “each odd-numbered page/even-numbered page”. If the method is the method of “each odd-numbered page/even-numbered page”, the process advances to step S1108. If the method is not the method of “each odd-numbered page/even-numbered page”, that is, the method is the method of “all pages at once”, the process advances to step S1111.

FIG. 15AC shows an example of the collation value table 910 generated from the data shown in FIG. 15AA and the sequential number settings shown in FIG. 15AB. Contents of the collation value table 910 are the same as in FIG. 9AD and a description thereof will be omitted.

As described above, according to the second embodiment, it is possible to provide an inspection system capable of selecting whether to duplicate an inspection region for all pages at once, for each odd-numbered page, or for each even-numbered page in the case of a double-sided print job.

### Third Embodiment

The above-described second embodiment has explained the method of switching the duplication method in sequential number inspection by the job information and user selection. However, in the method of the second embodiment, the inspection region is duplicated for each odd-numbered page/even-numbered page or for all pages at once. Therefore, the inspection region is unwantedly duplicated in an intentionally inserted blank page, and thus the inspection region is unwantedly set in a page for which sequential number inspection is unnecessary.

A third embodiment will describe a method of not duplicating an inspection region in a blank page. In the third embodiment, portions different from the above-described first and second embodiments will be described below. Note that portions not described in detail are the same as in the first and second embodiments.

FIG. 15BA depicts a view for explaining an example of data in which a blank page is inserted according to the third embodiment. FIG. 15BA shows, for example, a case where a blank page is inserted to between pages where a chapter of a book changes. In the example shown in FIG. 15BA, two sheets denoted by reference numerals 1510 and 1511 are printed. Each sheet undergoes double-sided printing, front side images are denoted by reference numerals 1512 and 1514, and back side images are denoted by reference numerals 1513 and 1515. Page numbers 1516, 1517, and 1519 are arranged at the centers of the lower portions of the first, second, and fourth pages, respectively, that are not blank. The page number has a start number “001” and increases by an offset “1”. Therefore, in this case, the sequential number settings are as shown in FIG. 15BB. A sequential number inspection region is not to be duplicated in the thus intentionally inserted blank page.

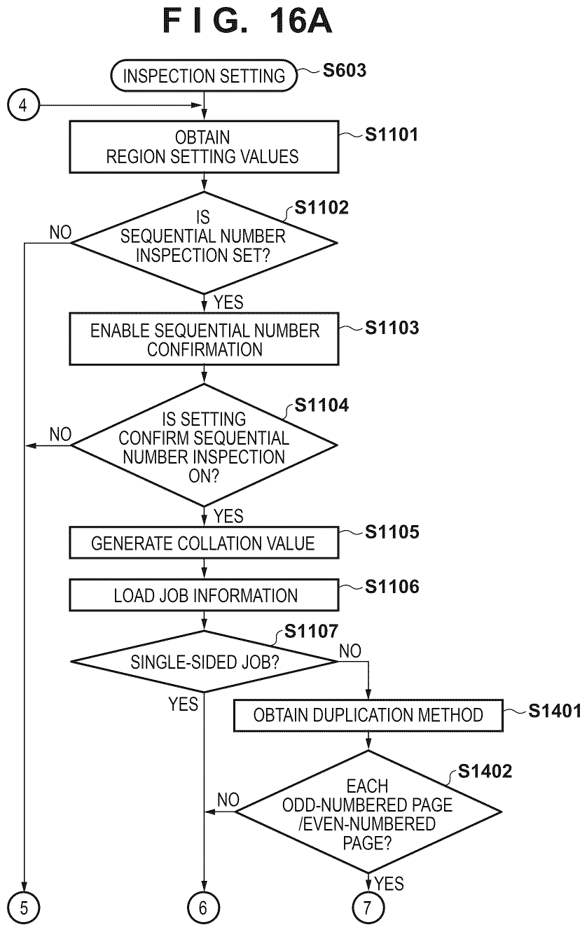

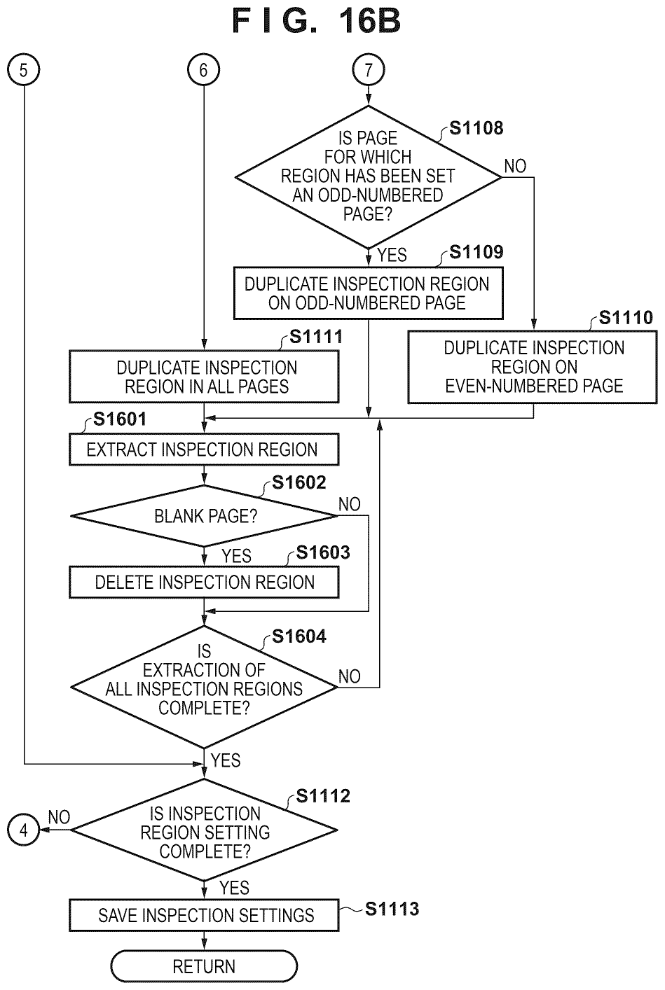

Inspection setting processing in step S603 according to the third embodiment will be described next with reference to a flowchart shown in FIGS. 16A and 16B.

FIGS. 16A and 16B are flowcharts for explaining the inspection setting processing in step S603 according to the third embodiment. Note that in FIGS. 16A and 16B, the same reference symbols as in FIG. 11 according to the first embodiment and FIGS. 14A and 14B according to the second embodiment denote the same processes and a description thereof will be omitted. Note that processes shown in this flowchart are implemented when the CPU 302 of the inspection apparatus 110 deploys program codes stored in the ROM 304 to the RAM 303, and reads out and executes the program codes deployed to the RAM 303.

If duplication of an inspection region ends in step S1111, S1109, or S1110, the process advances to step S1601, and the CPU 302 functions as the inspection control module 524 to extract one sequential number inspection region from the collation value table 910. Then, the process advances to step S1602, and the CPU 302 functions as the inspection control module 524 to determine whether a page in which the sequential number inspection region extracted in step S1601 is set is a blank page. Whether the page is a black page may be determined by a method of confirming bitmap data of a reference image or a method of including the page number of the blank page in job information transmitted by the print control apparatus 140. If it is determined in step S1602 that the page is a blank page, the process advances to step S1603. If it is determined in step S1602 that the page is not a blank page, the process advances to step S1604. In step S1603, the CPU 302 functions as the inspection control module 524 to delete the sequential inspection region extracted from the blank page. More specifically, a row corresponding to the blank page in the collation value table 910 is deleted. Then, the process advances to step S1604, and the CPU 302 functions as the inspection control module 524 to determine whether extraction of all sequential number inspection regions is complete. If it is determined that extraction of all sequential number inspection regions is complete, the process advances to step S1112. If it is determined that extraction of all sequential number inspection regions is not complete, the process returns to step S1601.

FIG. 15BC shows an example of a collation value table 1520 generated from the data shown in FIG. 15BA and the settings shown in FIG. 15BB. As compared to FIG. 9AD, it is understood that the row 918 corresponding to page number 3 as a blank page is deleted by the processing in step S1603.

As described above, according to the third embodiment, it is possible to provide an inspection system capable of omitting inspection of a page for which sequential number inspection is unnecessary, by excluding a blank page from sequential number inspection targets.

### Fourth Embodiment

The above-described third embodiment has explained an example of not duplicating an inspection region in a blank page. However, in the method of the third embodiment, an inspection region is unwantedly duplicated in a page which is not a blank page and in which a sequential number is not arranged intentionally, and inspection is unwantedly performed for a page for which sequential number inspection is unnecessary.

A fourth embodiment will describe a method of not duplicating an inspection region in a page in which a sequential number is not arranged intentionally. In the fourth embodiment, portions different from the above-described first to third embodiments will be described below. Note that portions not described in detail are the same as in the first to third embodiments.

FIG. 8BB depicts a view showing an example of an inspection setting screen in a case where a currently selected setting region is a sequential number inspection region in the inspection apparatus 110 according to the fourth embodiment. Portions common to FIG. 8BA are denoted by the same reference numerals and a description thereof will be omitted.

A setting item 870 is an item for setting a number to be excluded from sequential numbers. A number input to the item 870 is excluded from sequential numbers. A plurality of numbers can be input to this item, and when a plurality of numbers are input, they are input by separating each number by a comma (,). A number input to the setting item 870 is saved as a region setting value.

FIGS. 15CA to 15CC depict views showing examples of data in which a sequential number is not arranged intentionally, sequential number settings, and a collation value table when inspection settings are to be made for all pages at once in a double-sided print job according to the fourth embodiment.

FIG. 15CA shows an example of data in which a sequential number is not arranged intentionally. FIG. 15CA shows, for example, a case where only a picture is printed over the entire page, for example, a double-page spread of a novel and a page number is not printed on the page including only the picture. In FIG. 15CA, three sheets denoted by reference numerals 1530, 1531, and 1532 are printed. Each sheet undergoes double-sided printing, front side images are denoted by reference numerals 1533, 1535, and 1537, and back side images are denoted by reference numerals 1534, 1536, and 1538. Page numbers 1539, 1540, 1541, and 1542 are arranged at the centers of the lower portions of the first, second, fourth, and sixth pages, respectively. The page number has a start number “001” and increases by an offset “1”, and the excluded numbers are “003” and “005” with reference to FIG. 8BB. Therefore, in this case, the sequential number settings are as shown in FIG. 15CB. A page in which a sequential number is not arranged intentionally is desirably excluded from sequential number inspection.

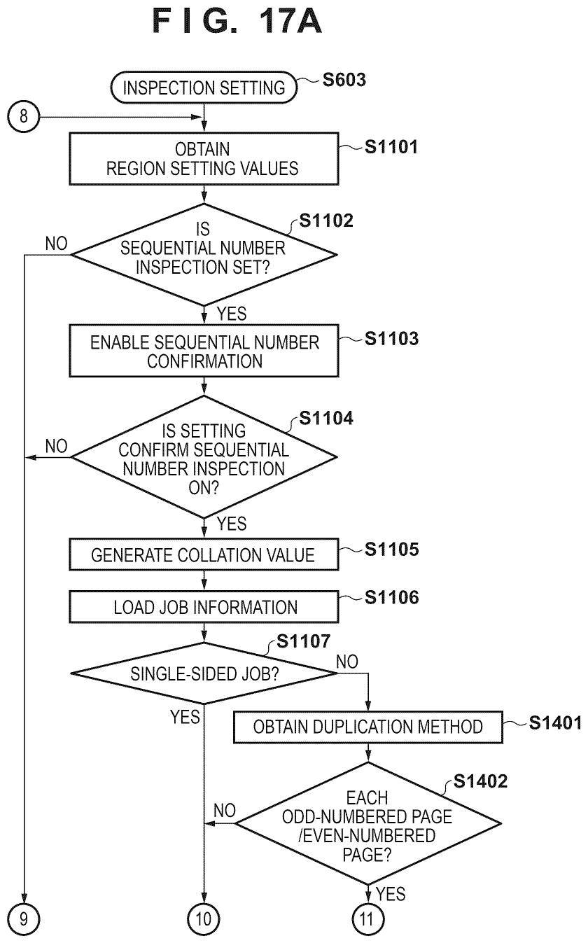

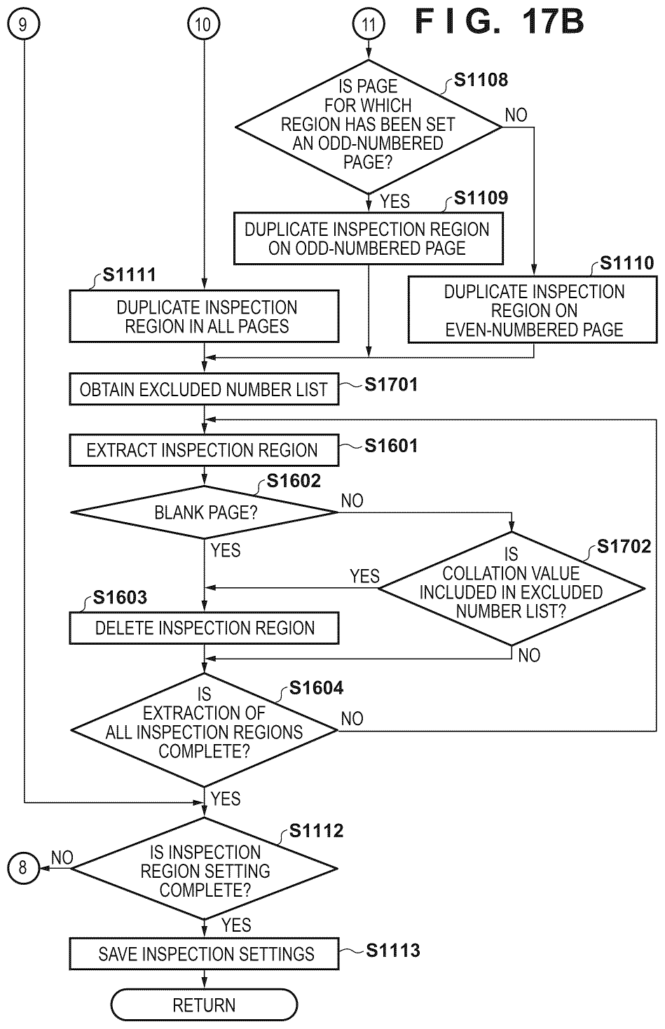

Inspection setting processing in step S603 according to the fourth embodiment will be described next with reference to a flowchart shown in FIGS. 17A and 17B.

FIGS. 17A and 17B are flowcharts for explaining the inspection setting processing in step S603 according to the fourth embodiment. Note that in FIGS. 17A and 17B, the same reference symbols as in FIG. 11 according to the first embodiment, FIGS. 14A and 14B according to the second embodiment, and FIGS. 16A and 16B according to the third embodiment denote the same processes and a description thereof will be omitted. Note that processes shown in this flowchart are implemented when the CPU 302 of the inspection apparatus 110 deploys program codes stored in the ROM 304 to the RAM 303, and reads out and executes the program codes deployed to the RAM 303.

If duplication of an inspection region ends in step S1111, S1109, or S1110, the process advances to step S1701, and the CPU 302 functions as the inspection control module 524 to obtain an excluded number list from the region setting values obtained in step S1101. If it is determined in step S1602 that a page is not a blank page, the process advances to step S1702, and the CPU 302 functions as the inspection control module 524 to obtain a collation value 915 with respect to a sequential number inspection region extracted in step S1601. Then, it is determined whether the collation value is included in the excluded number list obtained in step S1701. If it is determined that the collation value is included, the process advances to step S1603 to delete the inspection region. On the other hand, if it is determined that collation value is not included, the process advances to step S1604.

FIG. 15CC shows an example a collation value table 1543 generated from the data shown in FIG. 15CA and the sequential number settings shown in FIG. 15CB. The excluded numbers “003” and “005” are deleted from the collation value 915. As a result, only collation values “001”, “002”, “004”, and “006” of rows 1544, 1545, 1546, and 1547 are recorded.

As described above, according to the fourth embodiment, it is possible to provide an inspection system capable of excluding, from sequential number inspection targets, a page which is not a blank page and in which no sequential number is arranged.

### Fifth Embodiment

Each of the above-described embodiments up to the fourth embodiment has explained the method of creating a collation value table and deleting the sequential number inspection region of a page for which sequential number inspection is to be omitted, such as a blank page or a page in which a sequential number is not arranged intentionally. However, in the method according to each of the embodiments up to the fourth embodiment, after the collation value table is created, a specific inspection region and collation value are deleted, and thus the collation value unwantedly increases/decreases for the excluded page.

To cope with this, a fifth embodiment will describe a method of not increasing/decreasing a collation value for the excluded page. In the fifth embodiment, portions different from the above-described first to fourth embodiments will be described below. Note that portions not described in detail are the same as in the first to fourth embodiments.

FIG. 8C depicts a view showing an example of an inspection setting screen in a case where a currently selected setting region is a sequential number inspection region in the inspection apparatus 110 according to the fifth embodiment. Portions common to FIG. 8BB are denoted by the same reference numerals and a description thereof will be omitted.

A setting item 871 is an item for setting whether to skip increasing/decreasing the collation value (sequential number) of a page without any inspection region or a page including a sequential number to be excluded. A content set in the setting item 871 is saved as a region setting value in the RAM 303.

FIGS. 15DA to 15DC depict views showing examples of data for which it is set whether to skip increasing/decreasing the collation value (sequential number) of an excluded page, sequential number settings, and a collation value table when inspection settings are to be made for all pages at once in a double-sided print job according to the fifth embodiment.

FIG. 15DA shows an example of data in which the collation value is not to be increased/decreased for the excluded page. FIG. 15DA shows, for example, a case where direct mails printed with IDs are desirably sorted by inserting an interleaf sheet for every 10 sheets. In this case, 21 sheets including sheets denoted by reference numerals 1550, 1551, 1552, 1553, and 1554 and sheets not shown (sheets 2 to 9 and 13 to 19 are not illustrated) are printed. Each sheet undergoes single-sided printing, and IDs 1555, 1556, 1557, and 1558 are arranged at the centers of lower portions. To sort IDs 001 to 010 and IDs 011 to 020, a blank interleaf sheet is inserted as sheet 11 corresponding to the sheet 1552. The ID has a start number “001” and increases by an offset “1”. Therefore, in this case, the sequential number settings are as shown in FIG. 15 DB. As described above, it is set not to increase the ID with respect to an inserted blank sheet (sheet 11).

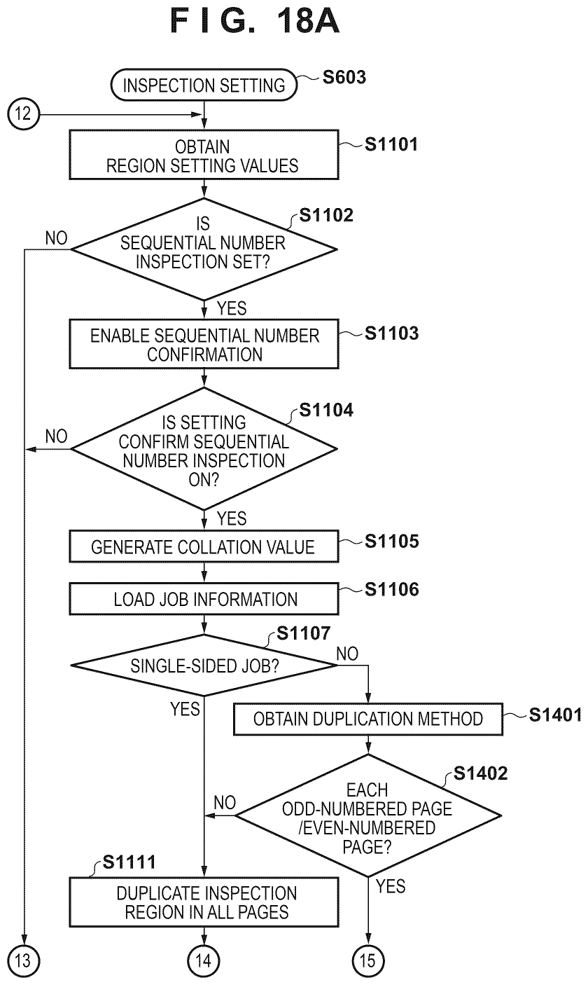

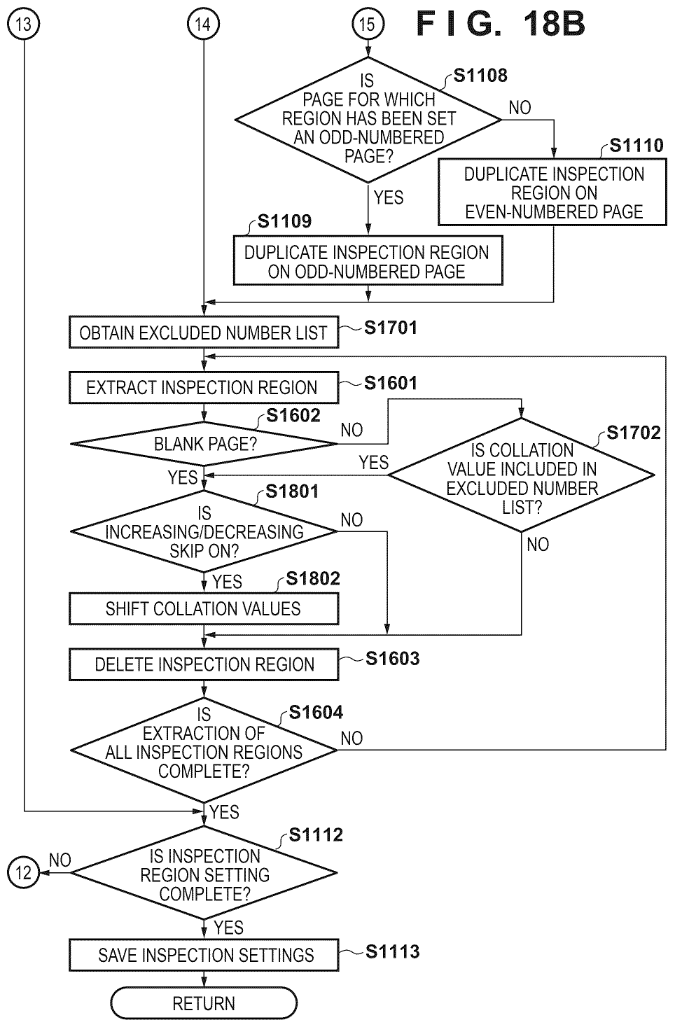

FIGS. 18A and 18B are flowcharts for explaining inspection setting processing in step S603 according to the fifth embodiment. Note that in FIGS. 18A and 18B, the same reference symbols as in FIG. 11 according to the first embodiment, FIGS. 14A and 14B according to the second embodiment, FIGS. 16A and 16B according to the third embodiment, and FIGS. 17A and 17B according to the fourth embodiment denote the same processes and a description thereof will be omitted. Note that processes shown in this flowchart are implemented when the CPU 302 of the inspection apparatus 110 deploys program codes stored in the ROM 304 to the RAM 303, and reads out and executes the program codes deployed to the RAM 303.

If it is determined in step S1602 that a page is a blank page or it is determined in step S1702 that a collation value matches an excluded number, the process advances to step S1801. In step S1801, the CPU 302 functions as the inspection control module 524 to obtain the collation value increasing/decreasing skip setting set in the setting item 871 shown in FIG. 8C from the region setting values obtained in step S1101 and determine whether the increasing/decreasing skip setting is ON. If the increasing/decreasing skip setting is ON, that is, the setting item 871 has been checked, the process advances to step S1802. If the increasing/decreasing skip setting is OFF, that is, the setting item 871 has not been checked, the process advances to step S1603. In step S1802, the CPU 302 functions as the inspection control module 524 to shift the collation values downward from the row of the extracted sequential number inspection region in the collation value table. That is, the collation value of the blank page is assigned to a subsequent page, and the collation values of the pages after that page are sequentially shifted and assigned.

The collation value table before the processing in step S1802 is a collation value table 1561 shown in FIG. 15DC. In the collation value table 1561, a collation value “011” is assigned to a row of page number 11. If the inspection region of page number 11 is extracted in step S1601, it is determined in step S1602 that the page is a blank page, and the process advances to step S1802, the collation values are sequentially shifted downward from the page of page number 11. As a result, a collation value table 1562 shown in FIG. 15CC is obtained. Since the row of page number 11 is deleted in step S1603, a collation value table 1560 shown in FIG. 15CC is finally obtained. As shown in FIG. 15 DB, by setting, as the excluded number, the number “011” corresponding to page number 11, it is determined in step S1702 that the collation value matches the excluded number, thereby obtaining the collation value table 1560 shown in FIG. 15CC.

As described above, according to the fifth embodiment, it is possible to provide an inspection system capable of selecting whether to exclude the collation value of a page to be excluded and to shift the collation value to a subsequent page.

The various examples and embodiments have been explained above but the spirit and scope of the present invention are not limited to a specific description in this specification. For example, the image forming apparatus 100 may include the print control apparatus 140.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-032524, filed Mar. 4, 2024, which is hereby incorporated by reference herein in their entirety.

What is claimed is:

1. An inspection system comprising an image forming apparatus and an inspection apparatus,
the image forming apparatus being configured to generate a printed material in accordance with a print job including print data and imposition information, and
the inspection apparatus including one or more controllers including one or more processors and one or more memories, the one or more controllers configured to:
obtain a scan image of the printed material by receiving and reading the printed material;
make inspection settings for a reference image;
perform inspection by comparing the scan image and the reference image; and
control, in a case where the inspection settings include sequential number inspection for inspecting a sequential number as a consecutive number and the imposition information indicates single-sided printing, to duplicate an inspection region set in the inspection settings for all pages,
wherein in the inspection, in a case where the sequential number inspection is set, the one or more controllers perform data collating inspection for comparing the number set in the inspection settings with a collation value.

2. The system according to claim 1, wherein in the control, in a case where the inspection settings include the sequential number inspection and the imposition information indicates double-sided printing, the one or more controllers duplicate the inspection region set in the inspection settings for each odd-numbered page or each even-numbered page.

3. The system according to claim 1, wherein, in a case where the inspection settings include the sequential number inspection and the imposition information indicates double-sided printing, the one or more controllers are able to further select whether to duplicate the inspection region for each odd-numbered page or each even-numbered page or for all pages.

4. The system according to claim 1, wherein, in the control, the one or more controllers further determine whether a page in which the inspection region is to be duplicated is a blank page, and control, in a case where it is determined that the page is the blank page, not to duplicate the inspection region in the blank page.

5. The system according to claim 1, wherein
the one or more controllers further set a number to be excluded from sequential numbers in the sequential number inspection, and
in the control, the one or more controllers control not to duplicate the inspection region in a page corresponding to the collation value matching the number to be excluded.

6. The system according to claim 1, wherein
the one or more controllers further set to skip increasing/decreasing the sequential number in a case where there is a page in the print job that is not a target of the sequential number inspection, and
in the control, in a case where it is set to skip increasing/decreasing the sequential number, the one or more controllers control to assign a collation value corresponding to a page not including the inspection region to a page subsequent to the page and to sequentially shift and assign collation values from the subsequent page.

7. The system according to claim 5, wherein the page that is not the target of the sequential number inspection is one of a page corresponding to a collation value matching a number set as the number to be excluded from sequential numbers in the sequential number inspection or a page not including the inspection region.

8. An inspection apparatus comprising one or more controllers including one or more processors and one or more memories, the one or more controllers configured to:
obtain a scan image of a printed material by receiving and reading the printed material generated in accordance with a print job including print data and imposition information;
make inspection settings for a reference image;
perform inspection by comparing the scan image and the reference image; and
control, in a case where the inspection settings include sequential number inspection for inspecting a sequential number as a consecutive number and the imposition information indicates single-sided printing, to duplicate an inspection region set in the inspection settings for all pages,
wherein in the inspection, in a case where the sequential number inspection is set, the one or more controllers perform data collating inspection for comparing the number set in the inspection settings with a collation value.

9. The apparatus according to claim 8, wherein in the control, in a case where the inspection settings include the sequential number inspection and the imposition information indicates double-sided printing, the one or more controllers duplicate the inspection region set in the inspection settings for each odd-numbered page or each even-numbered page.

10. The apparatus according to claim 8, wherein in a case where the inspection settings include the sequential number inspection and the imposition information indicates double-sided printing, the one or more controllers are able to further select whether to duplicate the inspection region for each odd-numbered page or each even-numbered page or for all pages.

11. The apparatus according to claim 8, wherein in the control, the one or more controllers further determine whether a page in which the inspection region is to be duplicated is a blank page, and control, in a case where it is determined that the page is the blank page, not to duplicate the inspection region in the blank page.

12. The apparatus according to claim 8, wherein
the one or more controllers further set a number to be excluded from sequential numbers in the sequential number inspection, and
in the control, the one or more controllers control not to duplicate the inspection region in a page corresponding to the collation value matching the number to be excluded.

13. The apparatus according to claim 8, wherein
the one or more controllers further set to skip increasing/decreasing the sequential number in a case where there is a page in the print job that is not a target of the sequential number inspection, and
in the control, in a case where it is set to skip increasing/decreasing the sequential number, the one or more controllers control to assign a collation value corresponding to a page not including the inspection region to a page subsequent to the page and to sequentially shift and assign collation values from the subsequent page.

14. The apparatus according to claim 12, wherein the page that is not a target of the sequential number inspection is one of a page corresponding to a collation value matching a number set as the number to be excluded from sequential numbers in the sequential number inspection and a page not including the inspection region.

15. The apparatus according to claim 8, wherein the inspection settings include at least a region where the sequential number is printed, information indicating whether the sequential numbers are in ascending order or descending order, a start number of the sequential number, and an offset as an increase value or a decrease value of the sequential number.

16. The apparatus according to claim 8, wherein in the control, the one or more controllers create and store a collation value table including the collation value corresponding to each page based on the inspection settings.

17. The apparatus according to claim 8, wherein the data collating inspection includes optical character recognition of a region, included in the scan image, where the sequential number is printed, and inspection of whether a number obtained by the optical character recognition matches the collation value.

18. A method of controlling an inspection apparatus, comprising:
obtaining a scan image of a printed material by receiving and reading the printed material generated in accordance with a print job including print data and imposition information;
making inspection settings for a reference image;
performing inspection by comparing the scan image and the reference image; and
controlling, in a case where the inspection settings include sequential number inspection for inspecting a sequential number as a consecutive number and the imposition information indicates single-sided printing, to duplicate an inspection region set in the inspection settings for all pages,
wherein in the performing inspection, in a case where the sequential number inspection is set, data collating inspection for comparing the number set in the inspection settings with a collation value is performed.
